(19) United States
(12) Patent Application Publication
(10) Pub. No.: US 2026/0281846 A1
(43) Pub. Date: Sep. 17, 2026

(54) METHOD AND APPARATUS FOR USE IN MANAGING HANDOVER OF A RELAY USER EQUIPMENT

(71) Applicant: CANON KABUSHIKI KAISHA, Tokyo (JP)

(72) Inventors: Pascal LAGRANGE, LA CHAPELLE DES FOUGERETZ (FR); Romain GUIGNARD, RENNES (FR); Walaa SAHYOUN, RENNES (FR)

(21) Appl. No.: 19/472,582

(22) PCT Filed: Apr. 2, 2024
(86) PCT No.: PCT/EP2024/058946

§ 371 Date: Oct. 3, 2025

(30) Foreign Application Priority Data
Apr. 6, 2023 (WO) PCT/FR2023/000037
Apr. 20, 2023 (GB) 2305844.9
May 9, 2023 (GB) 2306844.8

(51) Int. Cl. H04W 36/02; H04W 88/04; H04W 92/18

(52) U.S. Cl. CPC H04W 36/02; H04W 88/04; H04W 92/18

(57) ABSTRACT

A method for use in managing handover of a relay user equipment, UE, from a source base station to a target base station, the relay UE serving one or more remote UEs via one or more sidelink connections, is disclosed. The method at the source base station comprises sending, to the target base station, a handover request for the relay UE and sending, to the target base station, remote UE information associated with all or some of the one or more remote UEs served by the relay UE. The remote UE information may be sent as part of managing handover of the relay UE. In an example, the remote UE information is associated with the remote UEs which would remain connected to the relay UE after handover for the relay UE is completed. Methods at the target base station and relay UE and apparatus are also disclosed.

### FIELD OF THE INVENTION

The present invention generally relates to managing handover of a relay User Equipment, UE, in a sidelink relay-based network of a wireless communication system. More particularly, the present invention relates to managing the handover of a Relay UE and its served Remote UE(s) in a cellular sidelink relay-based network of a wireless communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP®) standards, such as fourth-generation (4G) Long Term Evolution (LTE) or recent fifth-generation (5G) New Radio (NR) systems, or systems based on IEEE 802.11 standards, such as WiFi.

In order to support new vehicle-to-anything (V2X) scenarios in the context of road safety services, 3GPP introduced NR sidelink (SL) communications, or PC5 communications, in 3GPP Release 16. The purpose of such technology was to provide support for broadcast, groupcast and unicast communications between any two User Equipments (UEs) in both out-of-coverage and in-network coverage scenarios.

Based on the NR sidelink technology, 3GPP introduced the sidelink-based relaying functionality as part of the 3GPP Release 17 framework, where a relay UE may provide User Plane (UP) and Control Plane (CP) data relaying between a set of served remote UEs and the network (UE-to-network, or U2N, relay) or between a source remote UE, or source UE, and a target remote UE, or target UE (UE-to-UE, or U2U relay).

The purpose of the Release 17 sidelink relaying functionality was to both extend sidelink/network coverage and improve power efficiency, while considering a wider range of applications and services, including V2X, Public Safety and commercial applications and services. Some of these new V2X scenarios require ultra-reliability and low latency (URLLC) performance, in order to meet high-speed and high-density constraints, while requiring some network coverage extension, which may be achieved through sidelink relaying.

This first version of the sidelink relaying functionality, as defined in the Release 17 specification, mainly aimed at supporting the UE-to-network (U2N) relay while setting the foundations for the UE-to-UE (U2U) relay, to be further studied in 3GPP Release 18.

Along with the support of the new Release 18 UE-to-UE (U2U) relay use cases, 3GPP is also considering further enhancements to the existing Release 17 Sidelink Relay specification, which aim at ensuring service continuity, by allowing flexible inter/intra-base station (for 5G NR the base station is referred to as a gNB) path switching, while improving reliability/robustness and throughput, with the support of multi-path with relay.

Ensuring service continuity in a 3GPP network based on sidelink relay raises the issue of ensuring lossless data delivery when performing inter-gNB path switch for a remote UE switching between a Source base station, or Source gNB (S-gNB), and a Target base station, or Target gNB (T-gNB) from an indirect path (i.e., the remote UE is connected to the Source base station through a relay UE) to a direct path (i.e., a remote UE is directly connected to the Target base station), or from an indirect path (i.e., the remote UE is connected to the Source base station through a relay UE) to another indirect path (i.e., the remote UE is connected to the Target base station through a relay UE).

Indeed, when considering a downlink data transmission from a Source base station, or Source gNB (S-gNB), to a remote UE over an indirect path, the Source gNB may successfully transmit some data packets to the relay UE and obtain from the relay UE some transmission acknowledgement for the received data packets, while the relay UE has not yet obtained the transmission acknowledgement for the same data packets from the remote UE. Therefore, considering 3GPP Rel-17 specifications, in case the remote UE did not actually receive some of the packets forwarded by the relay UE, such data packets may not be retransmitted by the Source gNB in case a path switch of the remote UE from the Source gNB to a target gNB occurs.

A similar issue may be encountered when considering uplink data transmission from a remote UE to a Source gNB when a path switch of the remote UE from the Source gNB to a target gNB occurs.

Therefore, some new mechanisms are required to ensure lossless data delivery when performing inter-gNB path switching from an indirect path, while limiting the complexity of the processing at a base station, as well as the signalling load associated to such processing and the latency that may result from such mechanisms and the associated message exchanges.

### SUMMARY

In accordance with a first aspect of the invention there is provided a method for use in managing data delivery in a wireless communication system comprising a plurality of nodes for communicating data between a source base station and a remote User Equipment, UE, node via at least one relay node in a multi-hop communication path, the method at the remote UE node comprising:
detecting a triggering event relating to a path switch, for the remote UE, to a new communication path; and
following detection of the triggering event, sending a status report indicating data packets received by the remote UE node.
   Optionally, the triggering event comprises receiving, at the remote UE node, a request for sending a downlink Packet Data Convergence Protocol, PDCP, status report.
   Optionally, the request for sending a PDCP status report is received from the source base station.
   Optionally, the triggering event comprises receiving, at the remote UE node, a path switch configuration for performing a path switch to the new communication path.
   Optionally, the path switch configuration is received from the source base station.
   Optionally, the path switch configuration is received from the relay node.
   Optionally, the status report indicating data packets received by the remote UE node is a Packet Data Convergence Protocol, PDCP, status report.
   In accordance with a second aspect of the invention there is provided a method for use in managing data delivery in a wireless communication system comprising a plurality of nodes for communicating data between a source base station and a remote User Equipment, UE, node via at least one relay node in a multi-hop communication path, the method at the remote UE node comprising:
detecting a triggering event relating to a path switch, for the remote UE node, to a new communication path; and
following detection of the triggering event, receiving a status report indicating data packets received by the base station.
   Optionally, the triggering event comprises receiving, at the remote UE node, a path switch configuration for performing a path switch to the new communication path.
   Optionally, the path switch configuration is received from the source base station.
   Optionally, the path switch configuration is received from the relay node.
   Optionally, the status report indicating data packets received by the source base station is received in response to a request, from the UE node, for a status report indicating data packets received by the source base station.
   Optionally, the UE node initiates a timer upon detecting the triggering event, wherein the request, from the UE node, for a status report indicating data packets received by the source base station is sent if a status report indicating data packets received by the source base station is not received by the expiry of the timer.
   Optionally, the method further comprises:
updating, based on the status report indicating data packets received by the source base station node, a transmission status record.
   Optionally, the transmission status record is a local Packet Data Convergence Protocol, PDCP, transmission status record.
   Optionally, the method further comprises:
switching the remote UE to the new communication path, wherein the new communication path comprises a connection to a target base station; and
transmitting, based on the status report indicating data packets received by the source base station, to the target base station one or more packet of data indicated as having not been received by the source base station.
   Optionally, the request from the UE node is sent to the source base station upon reception of a path switch configuration from the source base station.
   Optionally, the request from the UE node is sent to the target base station once the remote UE has switched to the new communication path.
   In accordance with a third aspect of the invention there is provided a method for use in managing data delivery in a wireless communication system comprising a plurality of nodes for communicating data between a source base station and a remote UE node via at least one relay node in a multi-hop communication path, the method at the source base station comprising:
detecting a triggering event relating to a path switch, for the remote UE node, to a new communication path; and
following detection of the triggering event, sending a status report indicating data packets received by the source base station.
   Optionally, the triggering event comprises receiving, at the source base station, a request for sending a Packet Data Convergence Protocol, PDCP, status report.
   Optionally, the triggering event comprises sending, to the remote UE node, a path switch configuration for performing a path switch to the new communication path.
   Optionally, the triggering event comprises sending, to the relay node, a path switch configuration for performing a path switch to the new communication path.
   Optionally, the triggering event comprises receiving, at the source base station, a connection adaptation confirmation message from a target base station of the new communication path.
   Optionally, the connection adaptation confirmation message is a path switch acknowledgement message received from a target base station.
   Optionally, the status report indicating data packets received by the source base station is a Packet Data Convergence Protocol, PDCP, status report.
   In accordance with a fourth aspect of the invention there is provided a method for use in managing data delivery in a wireless communication system comprising a plurality of nodes for communicating data between a source base station and a remote User Equipment, UE, node via at least one relay node in a multi-hop communication path, the method at the source base station comprising:
detecting a triggering event relating to a path switch, for the remote UE node, to a new communication path; and
following detection of the triggering event, receiving a status report indicating data packets received by the remote UE node.
   Optionally, the triggering event comprises sending, to the remote UE node, a path switch configuration for performing a path switch to the new communication path.
   Optionally, the triggering event comprises sending, to the relay node, a path switch configuration for performing a path switch to the new communication path.
   Optionally, the triggering event comprises receiving, at the source base station, a connection adaptation confirmation message from a target base station of the new communication path.
   Optionally, the connection adaptation confirmation message is a path switch acknowledgement message received from a target base station.
   Optionally, the status report indicating data packets received by the remote UE node is received in response to a request, from the source base station, for a status report indicating data packets received by the remote UE node.
   Optionally, the source base station initiates a timer upon detecting the triggering event, wherein the request, from the source base station, for a status report indicating data packets received by the remote UE node is sent if a status report indicating data packets received by the remote UE node is not received by the expiry of the timer.
   Optionally, the method further comprises:
updating, based on the status report indicating data packets received by the remote UE node, a transmission status record.
   Optionally, the transmission status record is a local Packet Data Convergence Protocol, PDCP, transmission status record.
   Optionally, the method further comprises:
transmitting, to a target base station, information based on the status report indicating data packets received by the remote UE node, wherein the target base station belongs to the new communication path.
   Optionally, the transmitting, to a target base station, of information based on the status report indicating data packets received by the remote UE node is triggered by the reception of a status report indicating data packets received by the remote UE node
   Optionally, the method further comprises:
receiving a further status report indicating data packets received by the remote UE node; and
transmitting, to the target base station, update information based on the further status report to update the information previously transmitted to the target base station.
   According to a fifth aspect of the invention there is provided a method for use in managing data delivery in a wireless communication system comprising:
a plurality of nodes for communicating data between a source base station node and a remote User Equipment, UE, node via at least one relay node in a multi-hop communication path; and
a target base station node,
   the method at the target base station node comprising:
detecting a triggering event relating to a path switch, for the remote UE node, to a new communication path, wherein the new communication path comprises a connection between the remote UE node and the target base station node; and
following detection of the triggering event, receiving a status report indicating data packets received by the remote UE node.
   Optionally, the method further comprises:
updating, based on the status report, a reception status record indicating data packets received by the remote UE node.
   Optionally, the updating is based on a comparison of downlink reception status information received from the source base station and downlink reception status information received from the remote UE node.
   Optionally, the method further comprises:
requesting, from the source base station node, one or more data packet for which transmission to the remote UE node has been previously attempted based on the comparison of downlink reception status information received from the source base station and downlink reception status information received from the remote UE node.
   Optionally, the method further comprises:
receiving, from the source base station node, one or more data packet for which transmission to the remote UE node has been previously attempted.
   Optionally, the method further comprises:
transmitting, to the remote UE node, one or more data packet indicated as having not been received by the remote UE node in the status report indicating data packets received by the remote UE node.
   In accordance with a sixth aspect of the invention there is provided an apparatus for a sidelink relay communication system, the apparatus comprising:
one or more processing units configured to perform the method according to any of the first to fifth aspects.
   In accordance with a seventh aspect of the invention there is provided a computer program comprising instructions which, when the program is executed by a computer, cause the computer to carry out the control method according to any one of the first to fifth aspects.
   According to an eighth aspect of the invention there is provided a computer-readable medium carrying a computer program according to the seventh aspect.

### BRIEF DESCRIPTION OF THE DRAWINGS

Different aspects of the invention will now be described, by way of example only, and with reference to the following drawings in which:

FIG. 1 is a schematic diagram illustrating an example wireless communication system in which the present invention may be implemented according to one or more embodiments;

FIG. 2 is a schematic diagram illustrating user plane stacks of some protocol layers involved in sidelink relay operations for UE-to-network (U2N) based relaying;

FIG. 3 and FIG. 4 are schematic diagrams illustrating the potential data loss issue that may result from an inter-gNB patch switch in an example wireless communication system in which the present invention may be implemented according to one or more embodiments;

FIG. 5, FIG. 6 and FIG. 7 are schematic and simplified diagrams illustrating example message flows for managing the lossless data delivery when performing remote UE communication adaptation, such as inter-gNB path switch from an indirect path, in accordance with one or more embodiments of the invention;

FIG. 8 is a flowchart of a method performed at the source base station in accordance with one or more embodiments of the present invention;

FIG. 9 and FIG. 10 are flowcharts of methods performed at the remote UE in accordance with one or more embodiments of the present invention;

FIG. 11 illustrates a flowchart of methods performed at the target base station in accordance with one or more embodiments of the present invention;

FIG. 13, FIG. 14a and FIG. 14b are flowcharts of methods performed at the remote UE in accordance with one or more embodiments of the present invention;

FIG. 12, FIG. 15 and FIG. 16 are flowcharts of methods performed at the source base station in accordance with one or more embodiments of the present invention;

FIG. 17 and FIG. 18 are flowcharts of methods performed at the target base station in accordance with one or more embodiments of the present invention;

FIG. 19a and FIG. 19b are, respectively, flowcharts of methods performed at receiving and transmitting wireless communication devices in accordance with one or more embodiments of the present invention;

FIG. 19c is a flowchart of a method for sharing data transmission and reception status between a first and a second base station in accordance with one or more embodiments of the present invention;

FIG. 20 is a flowchart of a method for determining, by a transmitting wireless communication device, data received by a remote receiving wireless communication device in accordance with one or more embodiments of the present invention;

FIG. 21 is a block schematic diagram of an example wireless communication device in accordance with embodiments of the present invention.

FIGS. 22a, 22b, 22c and 22d are flowcharts of example methods for managing retransmission of missing data in accordance with one or more embodiments of the present invention; and

FIG. 23 is a flowchart of an example method for managing, by a first base station, the retransmission of missing data initially sent by the first base station through a relay UE to a remote UE according to one or more embodiments of the present invention.

### DETAILED DESCRIPTION

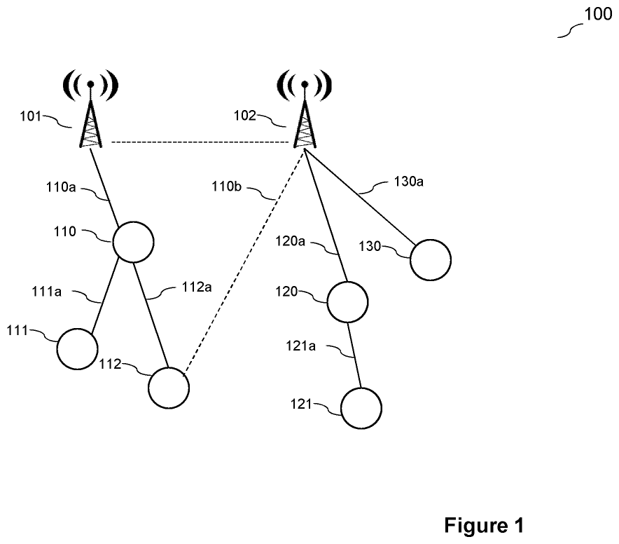

FIG. 1 represents an example of a wireless communication system 100 capable of supporting sidelink relay and shows a sidelink relay arrangement or system (or network) including a plurality of nodes including a relay User Equipment (UE) serving one or more remote User Equipment (UE).

For instance, in FIG. 1, UE node 110 is served by network node 101 and may operate as a relay UE node relaying data between one of the UE nodes 111, 112 (referred to as remote UE nodes) and the network node 101, hence performing UE-to-network (U2N) relay. In an example where the network node 101 is part of a cellular network, the relay UE 110 is served by a cell controlled by the network node 101.

UE node 120 is served by network node 102 and may also operate as a UE-to-network (U2N) relay UE node (for example, relaying data between the remote UE 121 and the network node 102).

UE node 130 is also served by network node 102 and may have some relaying capability, i.e. UE node 130 may act as a UE-to-network (U2N) relay UE at some time, even though it is not serving any remote UE at the time represented in FIG. 1.

The network nodes 101 and 102 may be base stations of a wireless network, such as a fifth-generation (5G) New Radio (NR) network or a Long Term Evolution (LTE) network. FIG. 1 only shows the base stations of the wireless network for clarity. For a 5G NR network, the network node 101, or 102, is referred to as a gNodeB, or gNB.

Even though sidelink relay is most likely to be considered in the context of V2X networks, it is not intended that the invention is limited to UE nodes that are in, or part of, a vehicle. Each of the UE nodes (relay or remote) may be a wireless communication device located in or part of a vehicle or a Road Side Unit (RSU) or a wireless communication device of a Vulnerable Road User (VRU) (e.g. a mobile or portable communication device (such as a smart phone, PDA, laptop, or similar devices) of a pedestrian or cyclist). In the following, a relay UE node will also be referred to as a relay UE, a remote UE node will also be referred to as a remote UE and a network node will be referred to as a gNB. Although in the following description, embodiments and examples of embodiments of the present invention will be described with respect to a 5G NR network, it will be appreciated that it is not intended that the present invention is limited to 5G NR systems and may be used in any wireless communication systems supporting sidelink (or peer to peer) relay communications.

In an example shown in FIG. 1, in a UE-to-Network (or U2N) scenario with the UE 110 (or UE 120) operating as UE-to-Network relay UE, the UE-to-Network relay UE 110 (or relay UE 120) connects the UEs 111 and 112 (or UE 121), operating as remote UEs, to the gNB 101 (or gNB 102). The remote UE 111 is connected to the relay UE 110 via or through a sidelink 111a which may be referred to as a PC5 hop or link or connection or interface 111a. Similarly, remote UE 112 and remote UE 121 have PC5 hops, or links or connections or interfaces 112a and 121a respectively with the relay UE 110 and relay UE 120. A Uu hop or link or connection or interface 110a connects the relay UE 110 to the gNB 101, while a Uu hop or link or connection or interface 120a and 130a respectively connect the relay UE 120 and the UE 130 to the gNB 102. PC5 connections are used for the relayed traffic of the remote UEs (111, 112 and 121) and the non-relayed traffic specific to the relay UE 110, 120, i.e. for the direct communications between relay UE 110, 120 and the other remote UEs (111, 112 and 121). Therefore, the remote UE 111 is connected to the gNB 101 through the relay UE 110 with a PC5 hop 111a and a Uu hop 110a. For uplink communication, the remote UE 111 is the source node (or transmitter node for transmitting data) and the gNB 101 is the destination or target node (or receiver node for receiving data) for a sidelink relay connection established between the remote UE 111 and the gNB 101 with a PC5 hop 111a and a second Uu hop 110a and for downlink communication, the remote UE 111 is the destination or target node (or receiver node) and the gNB 101 is the source node (or transmitter node). Similarly, the remote UE 121 is connected to the gNB 102 through the relay UE 120 with a PC5 hop 121a and a Uu hop 120a.

At some point, the gNB 101, acting as a source gNB, may decide to hand over the relay UE 110 to the gNB 102, which would then act as a target gNB. For example, in the case where the radio conditions in the serving cell (not shown in FIG. 1) controlled by the source gNB 101 deteriorate such that the radio conditions in the target cell (not shown in FIG. 1) controlled by the target gNB 102 are better than the serving cell, the source gNB 101 may decide to handover the relay UE 110 to the target gNB 102. In such a case, the relay UE 110 would detach from the source gNB 101, thereby releasing the Uu link 110a to further connect to the target gNB 102 through Uu link 110b (shown in dotted lines in FIG. 1) established as part of a re-establishment procedure.

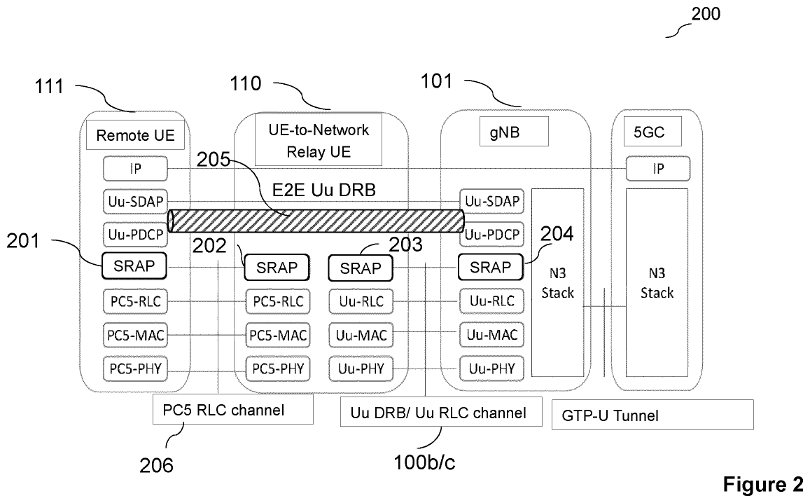

In order to set up a relayed traffic between a first node (remote UE) and a second node (gNB or another remote UE), a sidelink relay architecture may be used according to the 3GPP TR 38.836. The user plane architecture or protocol stack is shown in FIG. 2 and represents the sidelink relay adaptation layer called SRAP (i.e. Sidelink Relay Adaptation Protocol) that is introduced between the PDCP (Packet Data Convergence Protocol) layer and the RLC (Radio Link Control) layer at the extreme nodes and above the RLC layer in the relay UE. This architecture was first documented in the TR 38.836 and finally refined in 3GPP TS 38.300 while the SRAP layer is defined in 3GPP TS 38.351.

This architecture shown in FIG. 2 shows the sidelink relay architecture 200 for the UE-to-Network relay scenario. As shown in FIG. 2 illustrating a UE-to-Network relay scenario, the remote UE, such as remote UE 111, has a PC5 SRAP layer 201 between its Uu PDCP layer and it PC5 RLC layer.

As shown in FIG. 2 related to a UE-to-Network relay scenario, at the relay UE, such as relay UE 110, there are two SRAP layers to interface with the PC5 hop 111a and the Uu hop 110a: the PC5 SRAP layer 202 is connected to the PC5 SRAP 201 of the remote UE 111 through the PC5 hop 111a; and the Uu SRAP layer or entity 203 is connected to the Uu SRAP layer 204 at the gNB side 101 through the Uu link 110a. A remote UE 111 establishes End-to-End radio bearers 205 with the gNB 101. These radio bearers could be, for example, a Signalling Radio Bearer (SRB) and/or a Data Radio Bearer (DRB). FIG. 2 shows an E2E Uu DRB between the remote UE 111 and the gNB 101 by way of example.

The PC5 SRAP layer 202 of the UE-to-Network relay UE 110 receives data or packets (traffic data or signalling) over, or via, ingress PC5 RLC channels 206 from remote UE 111 (at PC5 hop 111a) in an uplink direction and transmits the packets to the Uu SRAP entity 203 of the same relay UE 110.

The Uu SRAP 203 entity will map the corresponding ingress PC5 RLC channels 206 to egress Uu RLC channels 100b and/or 100c at Uu link 110a. Thus, a mapping table is required for uplink and it is configured by gNB 101 at the Uu SRAP entity 203 of the relay UE 110.

The mapping table takes at its input an identifier of the remote UE 111 (e.g. L2-ID), an identifier of the E2E radio bearer 205 (e.g. the E2E Uu DRB 205 ID) and an identifier of the ingress PC5 RLC channel (or bearer) 206 and identifies the egress Uu RLC bearer ID where the E2E radio bearers are mapped. For example, the UE E2E bearer ID and remote UE ID can be obtained from the header of a data packet received at the Uu SRAP entity 203. An example of an entry for an uplink mapping table with one entry configured at the Uu SRAP entity 203 is shown in Table 1 below. It will be appreciated that the mapping table will be configured so that it has an entry for each remote UE connected to the relay UE.

TABLE 1

| | | Ingress PC5 RLC | Egress Uu RLC |
|---|---|---|---|
| UE ID | E2E Uu DRB ID | channel ID | channel ID |
| x1 | y1 | z1 | w1 |

At the Uu side or link 110a, different radio bearers of the same remote UE or different remote UEs can be subject to N:1 mapping and data multiplexing over Uu RLC channels 100b and 100c.

In the downlink direction, data or packets transmitted from gNB 101 arrive at the relay UE 110 through the Uu link 110a. The ingress Uu RLC channels 100b and 100c at the Uu SRAP entity 203 of the relay UE 110 will be mapped to the egress PC5 RLC channels 206 at PC5 hop 111a. The corresponding packets in downlink will be transmitted from the Uu SRAP entity 203 to the PC5 SRAP entity 202 to be then transmitted through the PC5 RLC channels 206 to the remote UE 111. Thus, a mapping table is required for downlink and it is configured by the gNB 101 at Uu SRAP entity 203 of the relay UE 110. The mapping table requires at its input the remote UE 111 L2-ID, the End-to-End radio bearer 205 ID and the ingress Uu RLC channel (or bearer) 100b and 100c ID and delivers the egress PC5 RLC channels (or bearer) 206 ID to the PC5 SRAP entity 202 of the same relay UE 110. The End-to-End Radio bearer 205 is then mapped at the PC5 hop 111a to the egress PC5 RLC channels 206. For example, the UE E2E bearer ID and remote UE ID can be obtained from the header of a packet received at the Uu SRAP entity 203. An example of a downlink mapping table with one entry configured at the Uu SRAP entity 203 is shown in Table 2 below. It will be appreciated that the mapping table will be configured so that it has an entry for each remote UE connected to the relay UE.

TABLE 2

| | | Egress PC5 RLC | Ingress Uu RLC |
|---|---|---|---|
| UE ID | E2E Uu DRB ID | channel ID | channel ID |
| x2 | y2 | z2 | w2 |

As mentioned in 3GPP TS 38.351, each SRAP entity has a transmitting part and a receiving part. Across the PC5 interface 111a, the transmitting part of the PC5 SRAP entity 201 at the remote UE 111 has a corresponding receiving part at PC5 SRAP entity 202 at the UE-to-Network Relay UE 110, and vice-versa. Across the Uu interface 110a, the transmitting part of the Uu SRAP entity 203 at the UE-to-Network Relay UE 110 has a corresponding receiving part at Uu SRAP entity 204 at the gNB 101, and vice-versa.

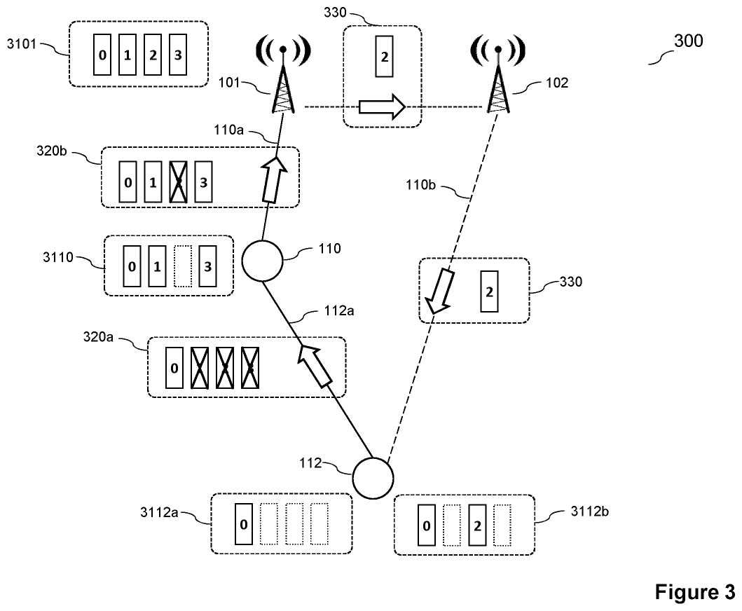

Referring now to FIG. 3 which is a schematic and simplified diagram illustrating a potential data loss issue that may result from an inter-gNB path switch in an example wireless communication system, such as system 100, in which the present invention may be implemented according to one or more embodiments.

According to an example, the gNB 101, also referred to as a Source gNB (S-gNB) 101 transmits a set 3101 of data packets {0, 1, 2, 3} to the remote UE 112 through the relay UE 110. However, the relay UE 110 only receives a subset 3110 of the transmitted packets, i.e., packets {0, 1, 3}. Therefore, the Source gNB (S-gNB) receives from the relay UE 110, over the Uu link 110a, an RLC acknowledge message 320b which indicates an acknowledge, or ACK, status for packets {0, 1, 3} and a non-acknowledge, or NACK, status for packet {2}.

The relay UE 110 forwards the packets {0, 1, 3} it received from the Source gNB 101 to the remote UE 112. However, the remote UE only receives a subset 3112a of the transmitted packets, i.e., packet {0}. Therefore, the relay UE 110 receives from the remote UE 112, over the PC5 link 112a, an RLC acknowledge message 320a which indicates an acknowledge, or ACK, status for packet {0} and a non-acknowledge, or NACK, status for packets {1, 2, 3}.

Then the remote UE 112 receives a path switch command from the Source gNB 101 and switches to the Target gNB (T-gNB) 102 for connection establishment.

According to the Rel-17 legacy data forwarding procedure, where only the unacknowledged data packets are forwarded by the S-gNB 101 to the T-gNB 102, the S-gNB 101 would only forward packet {2} (packet 330) to the T-gNB 102 for further retransmission to the remote UE 112.

Therefore, the remote UE 112 would only get a limited subset 3112b (made of packets {0, 2}) from S-gNB 101 initial transmission and T-gNB 102 retransmission and would thus suffer from data loss (i.e., packets {1, 3} are lost).

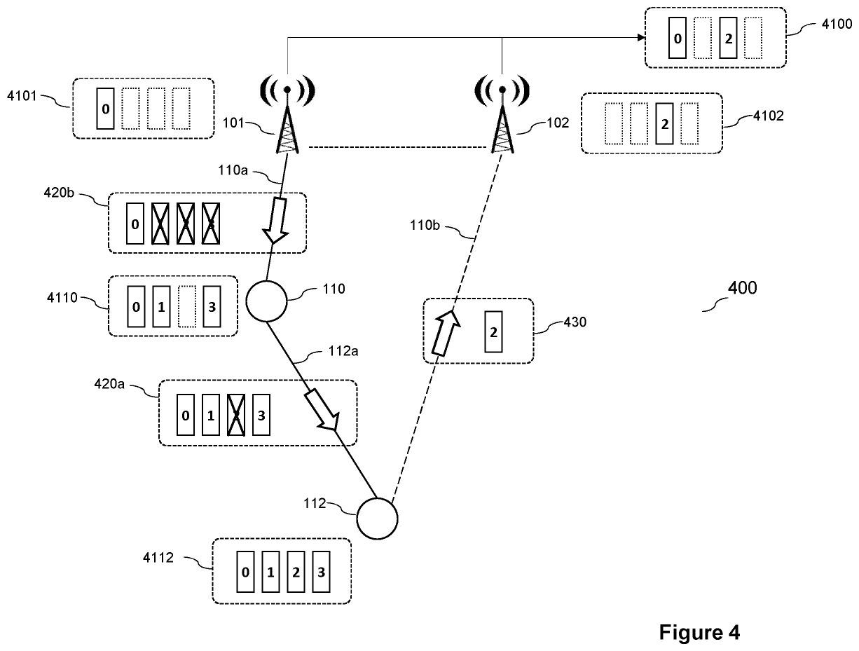

Referring now to FIG. 4 which is a schematic and simplified diagram illustrating a potential data loss issue that may result from an inter-gNB path switch in an example wireless communication system, such as system 100, in which the present invention may be implemented according to one or more embodiments.

According to an example, the remote UE 112 transmits a set 4112 of data packets {0, 1, 2, 3} to the Source gNB 101 through the relay UE 110. However, the relay UE 110 only receives a subset 4110 of the transmitted packets, i.e., packets {0, 1, 3}. Therefore, the remote UE 112 receives from the relay UE 110, over the PC5 link 112a, an RLC acknowledge message 420a which indicates an acknowledge, or ACK, status for packets {0, 1, 3} and a non-acknowledge, or NACK, status for packet {2}.

The relay UE forwards the packets {0, 1, 3} it received from the remote UE 112 to the Source gNB (S-gNB) 101. However, the Source gNB (S-gNB) 101 only receives a subset 4101 of the transmitted packets, i.e., packet {0}. Therefore, the relay UE 110 receives from the Source gNB (S-gNB) 4101, over the Uu link 110a, an RLC acknowledge message 420b which indicates an acknowledge, or ACK, status for packet {0} and a non-acknowledge, or NACK, status for packets {1, 2, 3}.

Then the remote UE 112 receives a path switch command from the Source gNB 101 and switches to the Target gNB (T-gNB) 102 for connection establishment.

According to the Rel-17 legacy data forwarding procedure, where only the unacknowledged data packets are retransmitted by the remote UE to the T-gNB 102, the remote UE will only retransmit packet {2} (packet 430) to the Target gNB (T-gNB).

Therefore, the core network connected to both the S-gNB 101 and the T-gNB 102 would only get a limited subset 4100 (i.e., packets {0, 2}), made of the packet subset 4101 (i.e., packet {0}) received from S-gNB 101 and the packet subset 4102 (i.e., packet {2}) received from T-gNB 102 and would thus suffer from data loss (i.e., packets {1, 3} are lost).

FIG. 19a is a flowchart of an example method for generating a PDCP reception status report by a receiving wireless communication device as defined in 3GPP TS 38.300, TS 38.331 and TS 38.323 and according to some aspects of the invention.

For example, with reference to the wireless communication system shown in and described with respect to FIG. 1, the receiving wireless communication device performing the method 1900a of FIG. 19a may be UE 112 or base station 101.

The method 1900a as shown in and described with respect to FIG. 19a, may be performed by software elements and/or hardware elements. The UE or the base station may be implemented in a communication device 2100 as shown in and described with reference to FIG. 21 with the method as shown in and described with respect to FIG. 19a being performed by one or more processing units, such as the central processing unit 2111.

In a first step 1901a, the PDCP layer of a receiving wireless communication device may determine the reception status of the data received from a remote transmitting wireless communication device based on the data actually received by the PDCP layer from the receiving lower layer, i.e., RLC layer, and update a PDCP reception status record accordingly.

According to one aspect of the invention, the PDCP reception status record is further referred to as an Uplink reception status record when the receiving wireless communication device is a base station.

In one example, the PDCP reception status record stores information associated to the sequence number (SN) of the one or more missing PDCP Service Data Units (SDU). In one aspect of the invention, such information may be a Bitmap or a list of missing sequence numbers (SN). The PDCP reception status record may therefore include some information associated to the sequence number (SN) of the one or more missing PDCP Service Data Units (SDU). This information may also be a Bitmap.

In a second step 1902a, the receiving wireless communication transmits a PDCP status report to the PDCP layer of the remote transmitting wireless communication device, as defined in TS 38.323, based on the latest version of the PDCP reception status record.

According to one aspect of the invention, the PDCP status report is further referred to as an Uplink reception status report when the receiving wireless communication device is a base station, such as base station 101.

According to one aspect of the invention, the PDCP status report is further referred to as a Downlink reception status report when the receiving wireless communication device is a UE device, such as remote UE device 112.

Referring now to FIG. 19b, which illustrates a flowchart of an example method for determining by a transmitting wireless communication device the data actually received by a remote receiving wireless communication device as defined in 3GPP TS 38.300, TS 38.331, TS 38.322 and TS 38.323 and according to some aspects of the invention.

For example, with reference to the wireless communication system shown in and described with respect to FIG. 1, the transmitting wireless communication device performing the method 1900b of FIG. 19b may be UE 112 or base station 101.

The method 1900b as shown in and described with respect to FIG. 19b, may be performed by software elements and/or hardware elements. The UE or the base station may be implemented in a communication device 2100 as shown in and described with reference to FIG. 21 with the method as shown in and described with respect to FIG. 19b being performed by one or more processing units, such as the central processing unit 2111.

In step 1901b, the PDCP layer of a transmitting wireless communication device receives all or part of:
an RLC reception status report associated to the data sent using Acknowledge Mode (AM), as defined in TS 38.322, to a receiving wireless communication device, where the RLC reception status report indicates which RLC Service Data Units (SDU), also referred to as PDCP Protocol Data Units (PDU), have been successfully received by the RLC layer of the receiving wireless communication device. In one example, the RLC reception status report is received by the PDCP layer of the transmitting wireless communication device from the RLC layer of the transmitting wireless communication device.
a PDCP status report received from the receiving wireless communication device, where the received PDCP status report is generated by the PDCP layer of the transmitting wireless communication device according to the method 1900a of FIG. 19a.

In one example, the PDCP layer of the transmitting wireless communication device updates a PDCP transmission status record based on the information carried by the most recent RLC reception status report and PDCP status report.

In one example, the PDCP transmission status record stores information associated to the sequence number (SN) of the one or more PDCP Service Data Units (SDU) that have not been received by the receiving wireless communication device.
In one aspect of the invention, such information may be one of the following:
a Bitmap recording the reception status by the receiving wireless communication device of all or part of the sequence numbers (SN) associated to PDCP Service Data Units (SDU) sent by the transmitting wireless communication device
a list of missing sequence numbers (SN) at the receiving wireless communication device.

According to one aspect of the invention, the PDCP transmission status record is referred to as a Downlink reception status record when the transmitting wireless communication device is a base station.

Referring now to FIG. 19c, which illustrates a flowchart of an example method for sharing data transmission and reception status between a first and a second base stations according to some aspects of the invention.

For example, with reference to the wireless communication system shown in and described with respect to FIG. 1, the transmitting wireless communication device performing the method 1900c of FIG. 19c may be base station 101.

The method 1900c as shown in and described with respect to FIG. 19c, may be performed by software elements and/or hardware elements. The base station may be implemented in a communication device 2100 as shown in and described with reference to FIG. 21 with the method as shown in and described with respect to FIG. 19c being performed by one or more processing units, such as the central processing unit 2111.

In step 1901c, a first base station transmits to a second base station a Xn Reception Status Information which includes all or part of:
an Uplink reception status information, which is based on the Uplink reception status record of the first base station, as discussed in method 1901a of FIG. 19a;
a Downlink reception status information based on the Downlink reception status record of the first base station, as discussed in method 1901b of FIG. 19b;

In one aspect of the invention, the Downlink reception status information is based on the Downlink reception status record of the first base station, as discussed in method 1901b of FIG. 19b and/or on the Sequence Number Information (SNI), as discussed in method 2300 of FIG. 23.

In relation with FIGS. 19a, 19b and 19c, it may be noted that the term “record” is equivalent to the term “scoreboard” or “table”.

In one example, the first base station is the Source base station, or S-gNB 101, while the second base station is the Target base station, or T-gNB 102.

According to one aspect of the invention, the Uplink reception status information and/or the Downlink reception status information are sent within one same message or within separate messages.

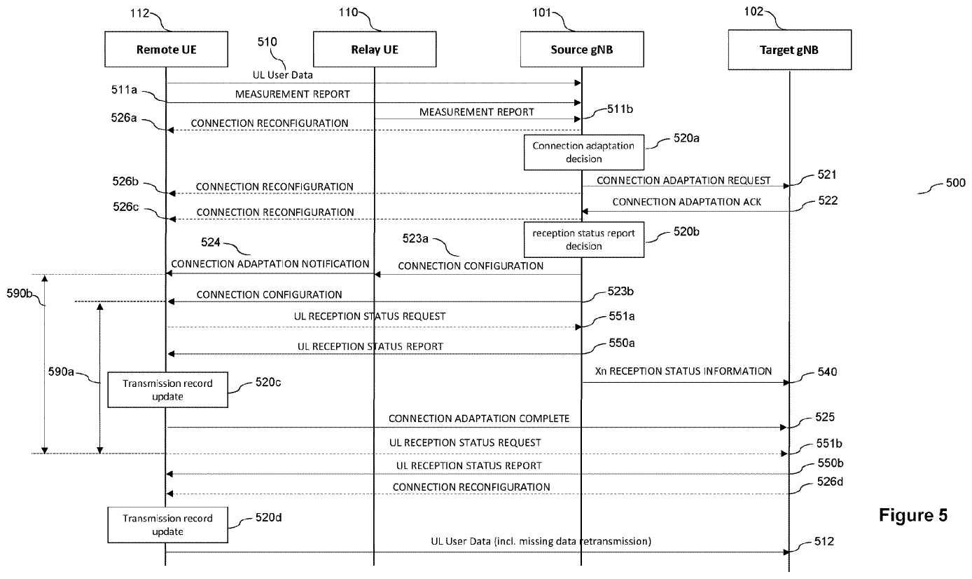

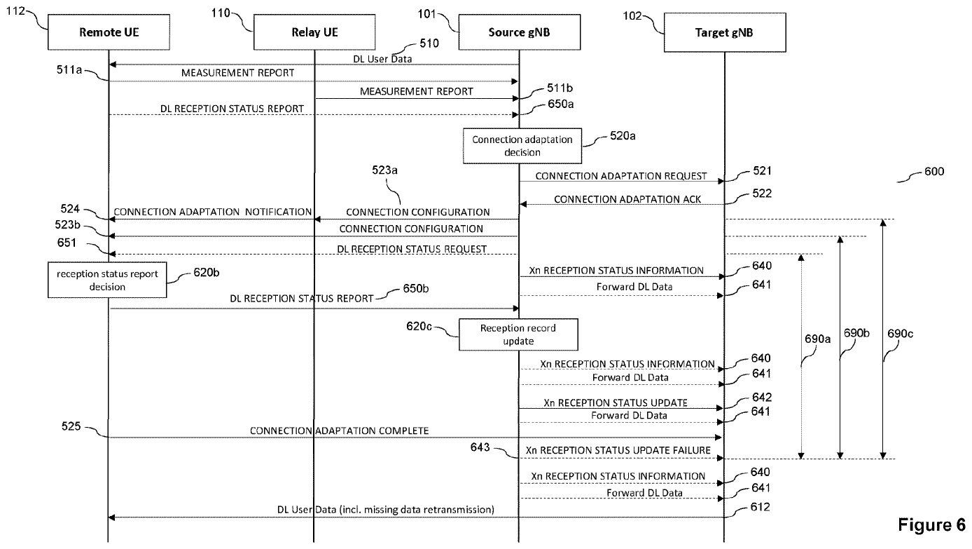

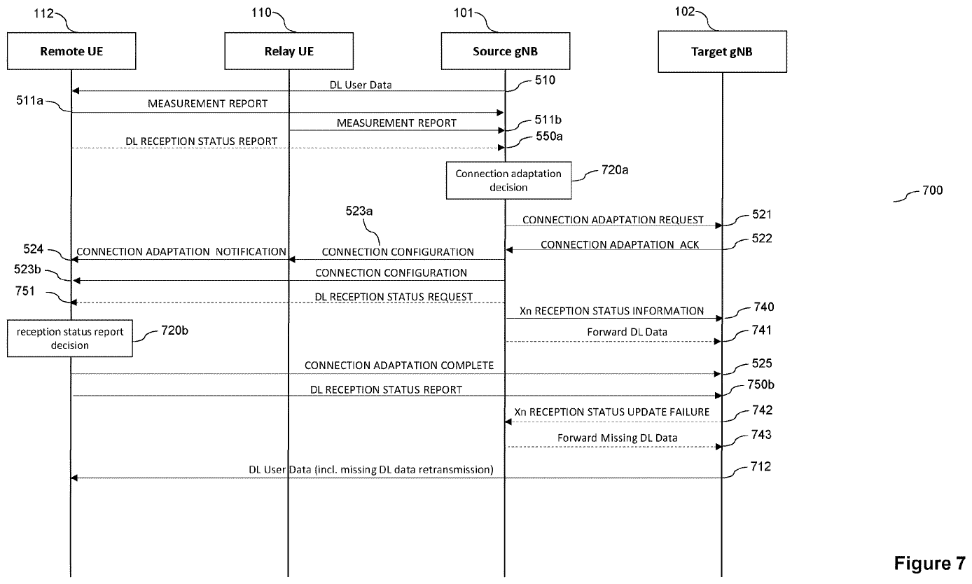

According to some aspect of the invention, the Uplink reception status information and/or the Downlink reception status information are sent by the first base station to the second base station within the Xn RECEPTION STATUS INFORMATION message 540, 640 or 740 discussed in FIG. 5, FIG. 6 or FIG. 7.

According to some aspect of the invention, the Uplink reception status information and/or the Downlink reception status information are sent by the first base station to the second base station within the Xn RECEPTION STATUS UPDATE message 642 discussed in FIG. 6.

Referring now to FIG. 20, which illustrates a flowchart of an example method for determining, by a transmitting wireless communication device, the data actually received by a remote receiving wireless communication device according to some aspects of the invention.

For example, with reference to the wireless communication system shown in and described with respect to FIG. 1, the transmitting wireless communication device performing the method 2000 of FIG. 20 may be UE 112 or base station 101.

The method 2000 as shown in and described with respect to FIG. 20, may be performed by software elements and/or hardware elements. The UE or the base station may be implemented in a communication device 2100 as shown in and described with reference to FIG. 21 with the method as shown in and described with respect to FIG. 20 being performed by one or more processing units, such as the central processing unit 2111.

In step 2001, the RLC layer of a transmitting wireless communication device configured in Acknowledge Mode (AM), as defined in 3GPP TS 38.322, may not provide the associated PDCP layer with the RLC reception status report discussed in method 1900b of FIG. 19b. This implies that said PDCP layer may build its PDCP transmission status record (or its Downlink reception status record in case the transmitting wireless communication device is a base station), as discussed in method 1900b of FIG. 19b, solely based on the latest PDCP status report received from the receiving wireless communication device.

By doing so, in case the transmitting wireless communication device is the source gNB 101, the Downlink reception status record at the source gNB 101 may include a list of missing sequence numbers (SN) at the receiving wireless communication device, which may be the remote UE 112, that is more extensive than it should be, as some further data packets associated to missing sequence numbers (SN) reported in the latest received PDCP status report may have been received by the remote UE 112 since the reception by the source gNB 101 of the latest PDCP status report.

In case the list of missing sequence numbers (SN) transmitted by the Source gNB 101 to a target gNB 102 is used by the Target gNB 102 to retransmit data to the remote UE 112, as discussed in method 600 of FIG. 6 or in method 700 of Figure, the Target gNB may thus retransmit a mix of data packets corresponding to received and missing sequence numbers (SN) at the remote UE 112 in case of remote UE path switch from the source gNB 101 to the target gNB 102. Even though the amount of retransmitted would be significantly greater than it should be (one may assume that the number of received sequence numbers (SN) is significantly greater than the number of missing sequence numbers), and the resources allocated for data retransmission would be thereby significantly increased, the method 2000 would ensure lossless data delivery to the remote UE 112, hence solving the issue discussed in FIG. 3.

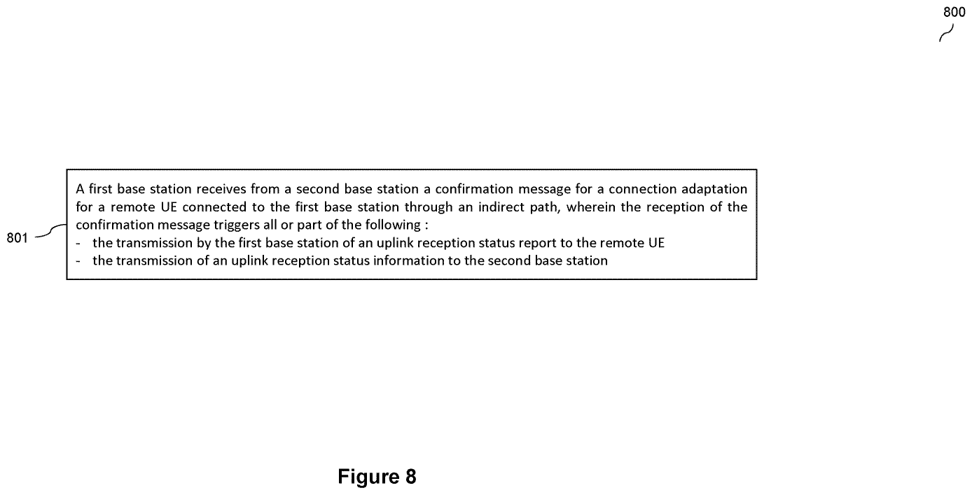

FIG. 8 is a flowchart of an example method for managing by a first base station the sharing of data reception status with other communication devices, such as a remote UE device connected to the first base station through a relay UE device, and/or a second base station, according to one or more embodiments of the present invention.

For example, with reference to the wireless communication system shown in and described with respect to FIG. 1, the first base station performing the method 800 of FIG. 8 may be the source base station 101, while the considered remote UE device, the relay UE and the second base station are respectively the remote UE 112, the relay UE 110 and the Target base station 102.

The method 800 as shown in and described with respect to FIG. 8, may be performed by software elements and/or hardware elements. The base station may be implemented in a communication device 2100 as shown in and described with reference to FIG. 21 with the method as shown in and described with respect to FIG. 8 being performed by one or more processing units, such as the central processing unit 2111.

In a step 801, a first base station, such as the source base station 101, requests to a second base station, such as the target base station 102, a connection adaptation for a remote UE, such as remote UE 112, connected to the source base station 101 via a relay UE, such as relay UE 110, served by the first base station.

In one example, the considered connection adaptation refers to the path switch of the remote UE from its current connection to the first base station through the relay UE to a direct connection to the second base station.

In another example, the considered connection adaptation refers to the handover (HO) of the relay UE from the first base station to the second base station.

In one aspect of the invention, the decision for requesting connection adaptation by the first base station is based on some measurement report information received either from the remote UE in case the considered connection adaptation refers to a path switch, or from the relay UE in case the considered connection adaptation refers to a handover (HO).

In one aspect of the invention, the first base station may decide to request connection adaptation to the second base station 102 if the link quality level, or the signal strength, of a cell served by the second base station 102 reported in the received measurement report information is greater than or equal to some predefined threshold or if the link quality level, or the signal strength, of a cell served by the second base station reported in the received measurement report information is greater from a predefined offset threshold than the link quality level, or the signal strength, of the cell to which the remote UE is connected.

According to one embodiment of the invention, link quality level, or the signal strength, measurements considered for connection adaptation decision include all or part of the following metrics: Reference Signal Received Power (RSRP), which provides a measure of the received power of the strongest reference signal from the considered cell; Reference Signal Received Quality (RSRQ), which provides a measure of the quality of the received reference signal from the considered cell, relative to the interference level in the cell; Signal-to-Noise Ratio (SNR), which provides a measure of the signal quality relative to the noise level in the cell and can be used to determine the strength of the signal from the considered cell; Channel Quality Indicator (CQI), which provides a measure of the quality of a received signal. In addition to the aforementioned metrics, other measurements such as cell identity, beamforming quality, and channel state information may also be considered for link quality level, or signal strength measurement.

According to one aspect of the invention, the request connection adaptation is performed by the first base station through a CONNECTION ADAPTATION REQUEST message 521, which is further described in FIG. 5.

According to one aspect of the invention, the measurement report information is received by the first base station 101 through a MEASUREMENT REPORT message 511a or 511b, as further described in FIG. 5.

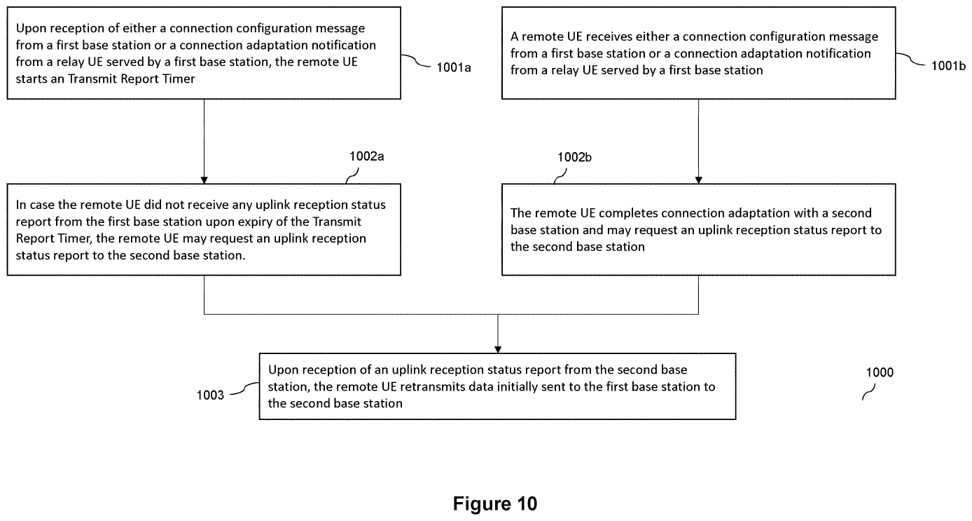

The reception by the first base station of a connection adaptation confirmation message from the second base station that indicates that the former connection adaptation request was accepted by the second base stations may trigger at the first base station of all or part of the following:
the transmission by the first base station to the remote UE of an Uplink reception status report, as discussed in step 1902a of FIG. 19a. In other words, the reception by the first base station of a message from the second base station that indicates that a former connection adaptation request was accepted by the second base station triggers at the first base station the transmission of a PDCP status report to the remote UE. This would allow the remote UE to have the knowledge of the latest data packets (and associated sequence numbers, or SN) received by the first base station before performing path switching to the second base station, thus mitigating the risk of lossy data delivery discussed in FIG. 4;
the transmission by the first base station to the second base station of an Uplink reception status information to the second base station through a Xn RECEPTION STATUS INFORMATION message 540, as discussed in method 1900c of FIG. 19c. By transmitting the Uplink reception status information to the second base station, the first base station may allow the second base station to provide an Uplink reception status report upon request from the remote UE in case the remote UE did not receive the Uplink reception status report transmitted by the first base station, as further discussed in method 1000 of FIG. 10.

According to one aspect of the invention, connection adaptation confirmation message received by the first base station from the second base station is the CONNECTION ADAPTATION ACK message 522, which is further described in FIG. 5.

In one aspect of the invention, the transmission of an Uplink reception status report to the remote UE may be performed along with the transmission of a connection configuration information to either the relay UE or the remote UE, using a connection configuration message.

In one aspect of the invention, the Uplink reception status report and the connection configuration information may be sent to the remote UE within one same connection configuration message or within separate messages.

According to one aspect of the invention, the aforementioned configuration message sent by the first base station to the relay UE is the CONNECTION CONFIGURATION message 523a, as further described in FIG. 5.

According to one aspect of the invention, the aforementioned configuration message sent by the first base station to the remote UE is the CONNECTION CONFIGURATION message 523b, as further described in FIG. 5.

According to one aspect of the invention, the Uplink reception status report is transmitted by the first base station through a UL RECEPTION STATUS REPORT message 550a, as further described in FIG. 5.

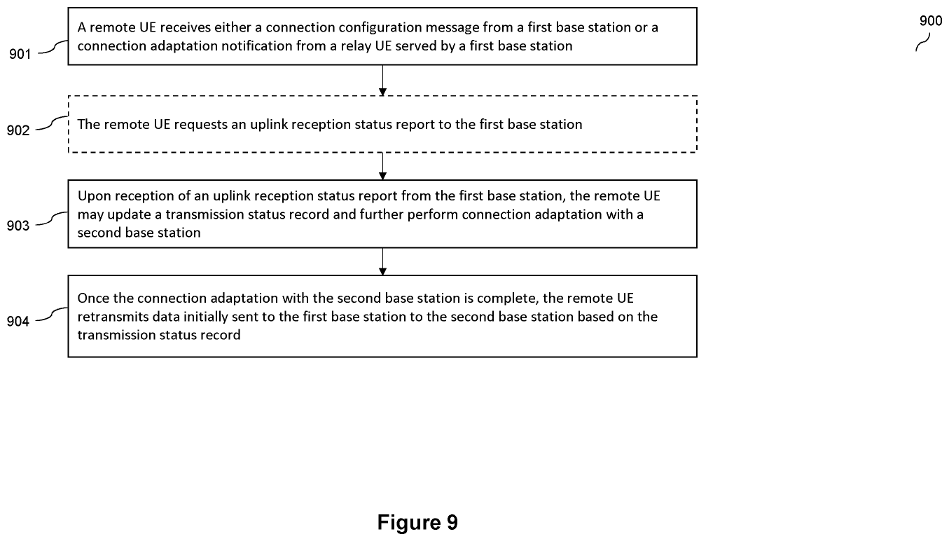

FIG. 9 is a flowchart of an example method for managing, by a remote UE, the retransmission of missing data initially sent to a first base station through a relay UE to a second base station according to one or more embodiments of the present invention.

For example, with reference to the wireless communication system shown in and described with respect to FIG. 1, the remote UE performing the method 900 of FIG. 9 may be the remote UE 112, while the considered first base station and second base station are respectively the source base station 101 and the target base station 102 and the considered relay UE is the relay UE 110.

The method 900 as shown in and described with respect to FIG. 9, may be performed by software elements and/or hardware elements. The remote UE node may be implemented in a communication device 2100 as shown in and described with reference to FIG. 21 with the method as shown in and described with respect to FIG. 9 being performed by one or more processing units, such as the central processing unit 2111.

In a first step 901, a remote UE may receive one of the following:
a connection configuration message received from a first base station to which the remote UE is connected through a relay UE.
a connection adaptation notification from a relay UE served by a first base station.

In one aspect of the invention, the connection configuration message may be associated to a connection adaptation of the remote UE, as discussed in method 800 of FIG. 8.

In one example, the connection adaptation refers to the path switch of the remote UE from its current connection to the first base station through the relay UE to a direct connection to a second base station.

In another example, the considered connection adaptation refers to the handover (HO) of the relay UE connecting the remote UE to the first base station from the first base station to the second base station.

According to one aspect of the invention, the aforementioned connection configuration message received by the remote UE is either the CONNECTION CONFIGURATION message 523b, or the CONNECTION ADAPTATION NOTIFICATION message 524 as further described in FIG. 5.

In one aspect of the invention, in step 902, upon reception of said connection configuration message, the remote UE may request an Uplink reception status report, as defined in method 1900a of FIG. 19a, from the first base station by issuing an UL RECEPTION STATUS REQUEST message 551a, defined in relation with FIG. 5.

In one aspect of the invention, step 902 may not be performed by the remote UE. In such case, the remote UE may skip step 902 and transition directly from step 901 to step 903.

In other words, the remote UE may receive some Uplink reception status report seamlessly, without requesting it from the first base station (step 901), or upon request (step 902).

The seamless approach may limit the message exchanges over the air interface, as well as the processing load at both first base station and remote UE, while the request-based approach may allow the remote UE to better control the timing of reception of the Uplink reception status report.

In step 903, the remote UE receives an Uplink reception status report, from the first base station and updates its local PDCP transmission status record accordingly, as defined in method 1900b of FIG. 19b.

In one aspect of the invention, the Uplink reception status report is received by the remote UE in an UL RECEPTION STATUS REPORT message defined in FIG. 5.

Then the remote UE performs connection adaptation according to the message it received in step 901.

According to one aspect of the invention, the remote UE receives in step 901 a CONNECTION CONFIGURATION message 523b which provides path switch configuration from an initial path, i.e., the current indirect path connecting the remote UE with the first base station through a relay UE, to a new path, i.e., a direct path with a second base station. In such case, once the remote UE updates its local PDCP transmission status record, it will perform path switch from the initial path to the new path.

According to one aspect of the invention, the remote UE received in step 901 a CONNECTION ADAPTATION NOTIFICATION message 524 which indicates that the relay UE connecting the remote UE to the first base station is performing a handover to a second base station. In one aspect of the invention, the CONNECTION ADAPTATION NOTIFICATION message 524 indicates the identifier of the target cell and/or the identifier of the second base station to which the relay UE is performing a handover. In such case, once the remote UE updates its local PDCP transmission status record, it may perform connection reestablishment with the second base station.

In one aspect of the invention, the remote UE may complete the connection adaptation process by sending to the first base station a CONNECTION ADAPTATION COMPLETE message 525, which is further described in FIG. 5.

Then, in step 904, once the connection adaptation with the second base station is complete, the remote UE may retransmit the data initially sent to the first base station through the relay UE to the second base station based on its last-updated PDCP transmission status record.

In one aspect of the invention, the remote UE may retransmit data packets, or PDCP Service Data Units (SDU), considered as missing by the first base station based on its last-updated PDCP transmission status record.

FIG. 10 is a flowchart of an example method for managing, by a remote UE, the retransmission of missing data initially sent to a first base station through a relay UE to a second base station according to one or more embodiments of the present invention.

For example, with reference to the wireless communication system shown in and described with respect to FIG. 1, the remote UE performing the method 1000 of FIG. 10 may be the remote UE 112, while the considered first base station and second base station are respectively the source base station 101 and the target base station 102 and the considered relay UE is the relay UE 110.

The method 1000 as shown in and described with respect to FIG. 10, may be performed by software elements and/or hardware elements. The remote UE node may be implemented in a communication device 2100 as shown in and described with reference to FIG. 21 with the method as shown in and described with respect to FIG. 10 being performed by one or more processing units, such as the central processing unit 2111.

In one aspect of the invention, the method 1000 of FIG. 10 starts at step 1001a.

In step 1001a, upon reception of either a connection configuration message from a first base station or a connection adaptation notification from a relay UE served by a first base station, the remote UE may start a Transmit Report Timer, where the connection configuration message is associated to a connection adaptation of the remote UE from the first base station to a second base station.

According to one aspect of the invention, the aforementioned connection configuration message received by the remote UE is the CONNECTION CONFIGURATION message 523b, as further described in FIG. 5.

According to one aspect of the invention, the aforementioned connection adaptation notification message received by the remote UE is the CONNECTION ADAPTATION NOTIFICATION message 524 as further described in FIG. 5.

According to one aspect of the invention, the Transmit Report Timer, started upon reception of a CONNECTION CONFIGURATION message 523b, is the Timer 590a further described in FIG. 5.

According to one aspect of the invention, the Transmit Report Timer, started upon reception of a CONNECTION ADAPTATION NOTIFICATION message 524, is the Timer 590b further described in FIG. 5.

Then, in step 1002a, in case the remote UE did not receive any Uplink reception status report from the first base station upon expiry of the Transmit Report Timer, the remote UE may request an uplink reception status report from the second base station using a UL RECEPTION STATUS REQUEST message 551b described in FIG. 5, once it has completed the connection adaptation process with the second base station.

In one aspect of the invention, the remote UE may not send any UL RECEPTION STATUS REQUEST message 551b to the second base station in step 1002a.

In another aspect of the invention, the method 1000 of FIG. 10 starts at step 1001b.

In step 1001b, a remote UE receives either a connection configuration message from a first base station or a connection adaptation notification from a relay UE served by a first base station, the remote UE may start Transmit Report Timer, where the connection configuration message is associated to a connection adaptation of the remote UE from the first base station to a second base station.

According to one aspect of the invention, the aforementioned connection configuration message received by the remote UE is the CONNECTION CONFIGURATION message 523b,

According to one aspect of the invention, the aforementioned connection adaptation notification message received by the remote UE is the CONNECTION ADAPTATION NOTIFICATION message 524 as further described in FIG. 5.

Then, in step 1002b, once the remote UE has completed a connection adaptation process from the first base station to a second base station, it may request an Uplink reception status report from the second base station using an UL RECEPTION STATUS REQUEST message 551b described in FIG. 5.

In one aspect of the invention, the remote UE may not send any UL RECEPTION STATUS REQUEST message 551b to the second base station in step 1002b.

In steps 1002a/1002b, the remote UE performs connection adaptation according to the message it received respectively in step 1001a/1001b.

According to one aspect of the invention, the remote UE may have received in step 1001a or 1001b, a CONNECTION CONFIGURATION message 523b which provides path switch configuration from an initial path, i.e., the current indirect path connecting the remote UE with the first base station through a relay UE, to a new path, i.e., a direct path with a second base station. In such cases, the remote UE performs path switch from the initial path to the new path in step 1002a/1002b.

According to one aspect of the invention, the remote UE receives in step 1001a/1001b, a CONNECTION ADAPTATION NOTIFICATION message 524 which indicates that the relay UE connecting the remote UE to the first base station is performing a handover to a second base station. In one aspect of the invention, the CONNECTION ADAPTATION NOTIFICATION message 524 indicates the identifier of the target cell and/or the identifier of the second base station to which the relay UE is performing a handover. In such cases, the remote UE performs connection reestablishment with the second base station in step 1002a/1002b.

In one aspect of the invention, the remote UE may complete the connection adaptation process in step 1002a or 1002b, by sending to the second base station a CONNECTION ADAPTATION COMPLETE message 525, which is further described in FIG. 5.

After completing either step 1002a or step 1002b, the remote UE may receive in step 1003 an Uplink reception status report from the second base station.

According to one aspect of the invention, the Uplink reception status report is received from the second base station through a UL RECEPTION STATUS REPORT message 550b, as further described in FIG. 5.

Upon reception of the UL RECEPTION STATUS REPORT message 550b, the remote UE may update its PDCP transmission status record, as discussed in method 1900b of FIG. 19b, and further retransmit to the second base station the data initially sent to the first base station through the relay UE to the second base station based on its updated PDCP transmission status record.

In one aspect of the invention, the remote UE may retransmit data packets, or PDCP Service Data Units (SDU), considered as missing by the first base station based on its updated PDCP transmission status record.

In other words, in one aspect of the invention (steps 1001a and 1002a), the remote UE may rely upon a simple timer mechanism, which start is triggered by the reception of a connection configuration message or a connection adaptation notification (step 1001a) to detect the non-reception of an Uplink reception status report. Indeed, as either the PC5 link between the remote UE and the relay UE or the Uu link between the relay UE and the first base station is weak enough for causing the first base station to perform remote UE connection adaptation (i.e., remote UE path switching or relay UE handover), the remote UE may not receive the Uplink reception status report at all, or may receive it after a significant time resulting from multiple retransmissions. It is therefore advantageous to monitor the actual reception of the Uplink reception status report, so as to be in a position of further requesting it from the second base station over a new link (i.e., a direct or an indirect link between the remote UE and the second base station) which is likely to be more reliable than the previous one (i.e., the indirect link between the remote UE and the first base station).

In another aspect of the invention (steps 1001b and 1002b), the remote UE may systematically request an Uplink reception status report to the second base station upon connection completion to the second base station. This approach, while ensuring the actual reception of an Uplink reception status report to be used for further retransmission and thus solving the issue of lossy uplink data delivery discussed in FIG. 4, may introduce some latency due to the aforementioned message exchanges between the remote UE and the second base station.

In another aspect of the invention, the second base station may systematically send an Uplink reception status report to the remote UE upon completion of the connection adaptation process by the remote UE. This approach may ensure that the Uplink reception status report is well received by the remote UE as it is sent over a reliable communication path between the remote UE and the second base station.

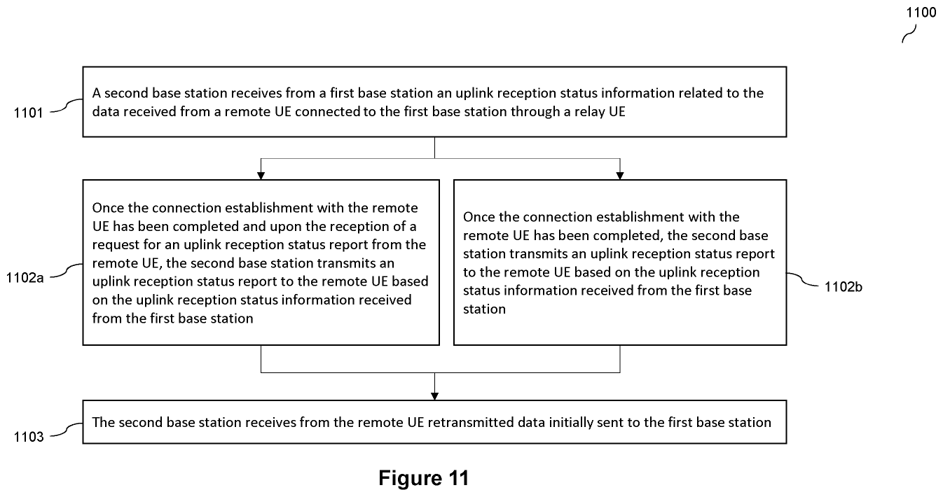

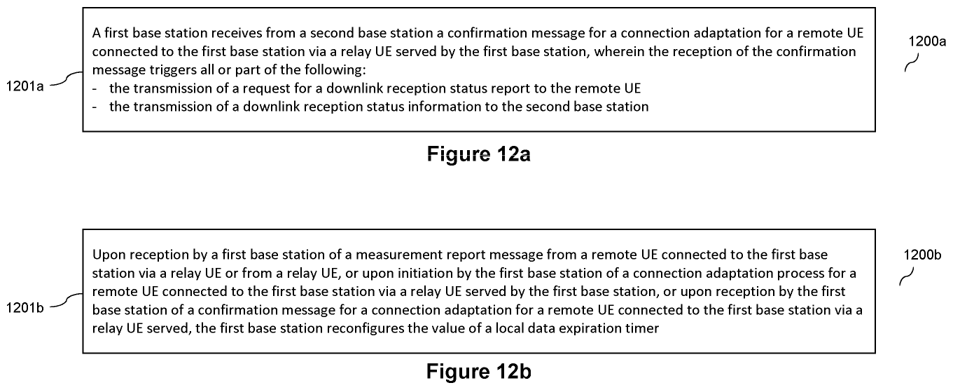

FIG. 11 is a flowchart of an example method for managing, by a second base station, the sharing with a remote UE device of the reception status of data initially sent by the remote UE device to a first base station through a relay UE device, according to one or more embodiments of the present invention.

For example, with reference to the wireless communication system shown in and described with respect to FIG. 1, the second base station performing the method 1100 of FIG. 11 may be the target base station 102, while the considered first base station, relay UE and remote UE are respectively the source base station 101, the relay UE 110 and the remote UE 112.

The method 1100a as shown in and described with respect to FIG. 11, may be performed by software elements and/or hardware elements. The base station may be implemented in a communication device 2100 as shown in and described with reference to FIG. 21 with the method as shown in and described with respect to FIG. 11 being performed by one or more processing units, such as the central processing unit 2111.

In a step 1101, a second base station receives from a first base station an Uplink reception status information, as defined in method 1900c of FIG. 19c, related to the reception status of the data received from a remote UE connected to the first base station through a relay UE.

According to one aspect of the invention, the Uplink reception status information is received by the second base station from the first base station through a Xn RECEPTION STATUS INFORMATION message 540 described in FIG. 5.

According to one aspect of the invention, the second base station performs step 1102a after completing step 1101 of method 110.

According to another aspect of the invention, the second base station performs step 1102b after completing step 1101 of method 110.

In step 1102a, once a connection establishment with the remote UE has been completed and upon the reception of a request for an Uplink reception status report, as discussed in method 1900a of FIG. 19a, from the remote UE, the second base station transmits an Uplink reception status report to the remote UE based on the uplink reception status information received from the first base station.

In one aspect of the invention, the information in the Uplink reception status report sent to the remote UE by the second base station includes all or part of the Uplink reception status information, as defined in method 1900c of FIG. 19c, embedded in the Uplink reception status report carried by the Xn RECEPTION STATUS INFORMATION message 540 received from the first base station by the second base station in step 1101.

In one aspect of the invention, the request for an Uplink reception status report is received by the second base station from the remote UE through the UL RECEPTION STATUS REQUEST message 551b defined in FIG. 5.

In one aspect of the invention, the Uplink reception status report is sent by the second base station to the remote UE through the UL RECEPTION STATUS REPORT message 550b defined in FIG. 5.

In step 1102b, once a connection establishment with the remote UE has been completed, the second base station transmits an Uplink reception status report to the remote UE based on the Uplink reception status information received through the Xn RECEPTION STATUS INFORMATION message 540 from the first base station in step 1101.

In one aspect of the invention, the information in the Uplink reception status report sent to the remote UE by the second base station includes all or part of the Uplink reception status information, as defined in method 1900c of FIG. 19c, carried by the Xn RECEPTION STATUS INFORMATION message 540 received from the first base station by the second base station in step 1101.

In one aspect of the invention, the Uplink reception status report is sent by the second base station to the remote UE through the UL RECEPTION STATUS REPORT message 550b defined in FIG. 5.

According to an aspect of the invention, the second base station performs step 1103 after completing either step 1102a or step 1102b of method 110.

In step 1103, the second base station may receive from the remote UE retransmitted data that was initially sent by the remote UE to the first base station.

In one aspect of the invention, said retransmitted data refers to all or part of the data packets or PDCP Protocol Data Units (PDU) which sequence numbers (SN) are associated to the UL RECEPTION STATUS REPORT message 550b sent to the second base station to the first base station in state 1102a, resp. 1102b.

In other words, according to one aspect of the invention (step 1102a), the second base station may rely on some former Uplink reception status information previously received from the first base station upon remote UE connection adaptation, to provide the remote UE the most up-to-date Uplink reception status report when the remote UE requests it, thereby solving the lossy uplink data delivery issue discussed in FIG. 4.

According to another aspect of the invention (step 1102b), the second base station may systematically send the most up-to-date Uplink reception status report to the remote UE upon connection completion of the remote UE to the second base station. This approach may limit the processing at the remote UE as the remote UE may not need to monitor the actual reception of the Uplink reception status report as discussed in method 1000 of FIG. 10. However, such approach may lead to the transmission of unnecessary messaging from the second base station (i.e., the systematic Uplink reception status report messages) in case the Uplink reception status report was correctly received from the first base station by the remote UE.

FIG. 12a is a flowchart of an example method for managing by a first base station the sharing of a data reception status with a second base station, according to one or more embodiments of the present invention.

For example, with reference to the wireless communication system shown in and described with respect to FIG. 1, the first base station performing the method 1200a of FIG. 12a may be the source base station 101, while the considered second base station is the target base station 102 and the considered remote UE and relay UE are respectively the remote UE 112 the relay UE 110.

The method 1200a as shown in and described with respect to FIG. 12a, may be performed by software elements and/or hardware elements. The base station may be implemented in a communication device 2100 as shown in and described with reference to FIG. 21 with the method as shown in and described with respect to FIG. 12a being performed by one or more processing units, such as the central processing unit 2111.

In a step 1201a, a first base station, such as the source base station 101, requests to a second base station, such as the target base station 102, a connection adaptation for a remote UE, such as remote UE 112, connected to the source base station 101 via a relay UE, such as relay UE 110, served by the first base station.

In one example, the considered connection adaptation refers to the path switch of the remote UE from its current indirect connection to the first base station, through the relay UE, to a direct connection to the second base station.

In another example, the considered connection adaptation refers to the handover (HO) of the relay UE from the first base station to the second base station.

In one aspect of the invention, the decision for requesting connection adaptation by the first base station is based on some measurement report information received either from the remote UE in case the considered connection adaptation refers to a path switch, or from the relay UE in case the considered connection adaptation refers to a handover (HO).

In one aspect of the invention, the first base station may decide to request connection adaptation to the second base station 102 if the link quality level, or the signal strength, of a cell served by the second base station 102 reported in the received measurement report information is greater than or equal to some predefined threshold or if the link quality level, or the signal strength, of a cell served by the second base station reported in the received measurement report information is greater from a predefined offset threshold than the link quality level, or the signal strength, of the cell to which the remote UE is connected.

According to one embodiment of the invention, link quality level, or the signal strength, measurements considered for connection adaptation decision include all or part of the following metrics: Reference Signal Received Power (RSRP), which provides a measure of the received power of the strongest reference signal from the considered cell; Reference Signal Received Quality (RSRQ), which provides a measure of the quality of the received reference signal from the considered cell, relative to the interference level in the cell; Signal-to-Noise Ratio (SNR), which provides a measure of the signal quality relative to the noise level in the cell and can be used to determine the strength of the signal from the considered cell; Channel Quality Indicator (CQI), which provides a measure of the quality of a received signal. In addition to the aforementioned metrics, other measurements such as cell identity, beamforming quality, and channel state information may also be considered for link quality level, or signal strength measurement.

According to one aspect of the invention, the request connection adaptation is performed by the first base station through a CONNECTION ADAPTATION REQUEST message 521, which is further described in FIG. 5.

According to one aspect of the invention, the measurement report information is received by the first base station 101 through a MEASUREMENT REPORT message 511a or 511b, as further described in FIG. 5.

The reception by the first base station of a connection adaptation confirmation message from the second base station that indicates that the former connection adaptation request was accepted by the second base station may trigger at the first base station of all or part of the following:
the transmission by the first base station to the remote UE of a request for a Downlink reception status report, as discussed method 1900a of FIG. 19a. In other words, the reception by the first base station of a message from the second base station that indicates that a former connection adaptation request was accepted by the second base station triggers at the first base station the transmission of a request for the remote UE to send a PDCP status report.
the transmission by the first base station to the second base station of a Downlink reception status information to the second base station through a Xn RECEPTION STATUS INFORMATION message 640 or 740 described in FIG. 6 or FIG. 7, as discussed in method 1900c of FIG. 19c. In one aspect of the invention, the first base station may also transmit all or part of the packet data, or PDCP Protocol Data Units (PDU), which sequence number (SN) is associated to the Downlink reception status information (see also the Forward DL Data 641, 741, described in FIG. 6 and FIG. 7).

According to one aspect of the invention, connection adaptation confirmation message received by the first base station from the second base station is the CONNECTION ADAPTATION ACK message 522, which is further described in FIG. 5.

In one aspect of the invention, the transmission to the remote UE of a request for a Downlink reception status report may be performed along with the transmission of a connection configuration information to either the relay UE or the remote UE, using a connection configuration message.

In one aspect of the invention, the request for a Downlink reception status report and the connection configuration information may be sent to the remote UE within one same connection configuration message or within separate messages.

In one aspect of the invention, the request for a Downlink reception status report is sent before sending the connection configuration information to either the relay UE or the remote UE.

According to one aspect of the invention, the aforementioned configuration message sent by the first base station to the relay UE is the CONNECTION CONFIGURATION message 523a, as further described in FIG. 5.

According to one aspect of the invention, the aforementioned configuration message sent by the first base station to the remote UE is the CONNECTION CONFIGURATION message 523b, as further described in FIG. 5.

According to one aspect of the invention, the request for a Downlink reception status report is transmitted by the first base station through a DL RECEPTION STATUS REQUEST message 651, as further described in FIG. 6.

FIG. 12b is a flowchart of an example method for managing, by a first base station, the retransmission of missing data initially sent by the first base station through a relay UE to a remote UE according to one or more embodiments of the present invention.

For example, with reference to the wireless communication system shown in and described with respect to FIG. 1, the first base station performing the method 1200b of FIG. 12b may be the source base station 101, while the considered second base station is the target base station 102 and the considered remote UE and relay UE are respectively the remote UE 112 the relay UE 110.

The method 1200b as shown in and described with respect to FIG. 12b, may be performed by software elements and/or hardware elements. The base station may be implemented in a communication device 2100 as shown in and described with reference to FIG. 21 with the method as shown in and described with respect to FIG. 12b being performed by one or more processing units, such as the central processing unit 2111.

In a step 1201b, the first base station may disable or extend the PDCP layer discardTimer, as defined in 3GPP TS 38.323, so as to prevent the discarding by the PDCP layer of data packets, or PDCP Protocol Data Units (PDU), previously transmitted by the first base station to the remote UE. This allows for the forwarding, to the second base station, of the non-discarded data packets, or PDCP Protocol Data Units (PDU), upon further request from the second base station.

In a step 1201b, a first base station may detect one of the following triggering events:
the first base station receives a measurement report message from a remote UE connected to the first base station via a relay UE or from a relay UE. In one example the measurement report message is the MEASUREMENT REPORT 511a or 511b, as defined in FIG. 5;
the first base station initiates a connection adaptation process, from the first base station to the second base station, for a remote UE connected to the first base station via a relay UE served by the first base station. In one aspect of the invention, the initiation of the connection adaptation process consists in detecting by the first base station the need for performing connection adaptation for the remote UE. In another aspect of the invention, the initiation of the connection adaptation process consists in sending to the second base station a connection adaptation request message, such as CONNECTION ADAPTATION REQUEST message 521, as defined in FIG. 5;
the first base station receives a confirmation message from a second base station for a connection adaptation for a remote UE connected to the first base station via a relay UE served by the first base station. In one example, the confirmation message is the CONNECTION ADAPTATION ACK message 522, as defined in FIG. 5.

In one aspect of the invention, the connection adaptation may refer to a path switch.

In one aspect of the invention, the connection adaptation may refer to a handover.

In one example, upon detection of any of the aforementioned triggering events, the first base station may reconfigure a local data expiration timer.

In one example, the reconfiguration of the data expiration timer may consist in increasing the value of the data expiration timer. In one example, the reconfiguration of the data expiration timer may consist in setting the value of the data expiration timer to an infinite value.

In one example, the reconfiguration of the data expiration timer may consist in disabling, or deactivating, or suspending the data expiration timer at the remote UE.

In one example, the data expiration timer is the PDCP layer discardTimer, as defined in 3GPP TS 38.323.

Reconfiguring the value of the data expiration timer may prevent the discarding by the base station's PDCP layer of data packets, or PDCP Protocol Data Units (PDU), previously transmitted by the first base station to the remote UE. This allows for further retransmission, to the remote UE, of the non-discarded data packets, or PDCP Protocol Data Units (PDU).

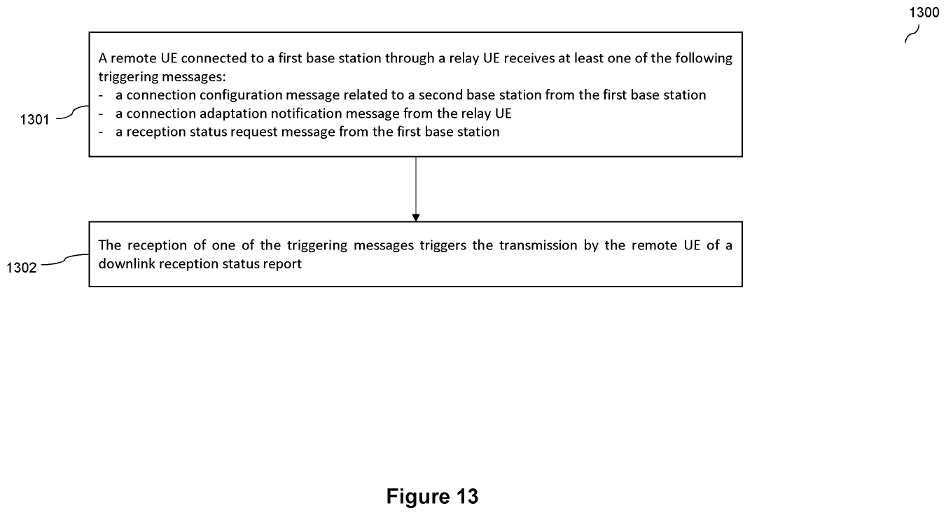

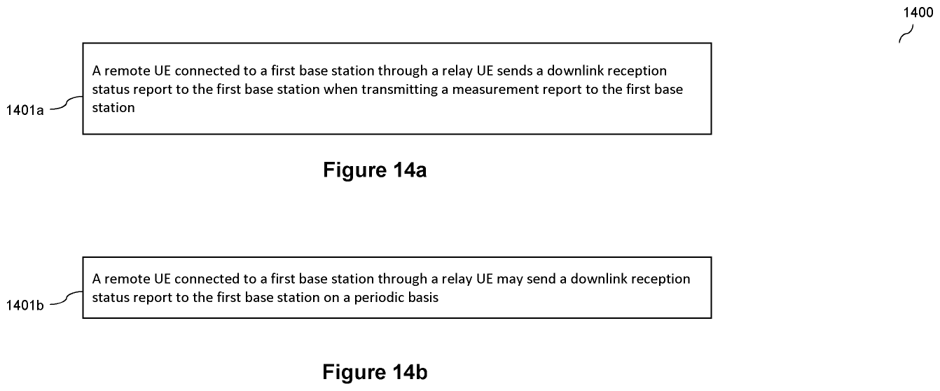

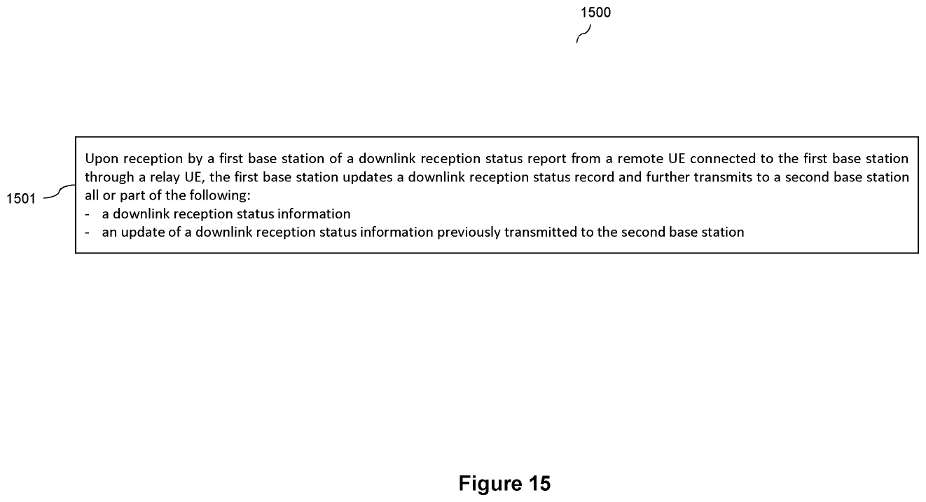

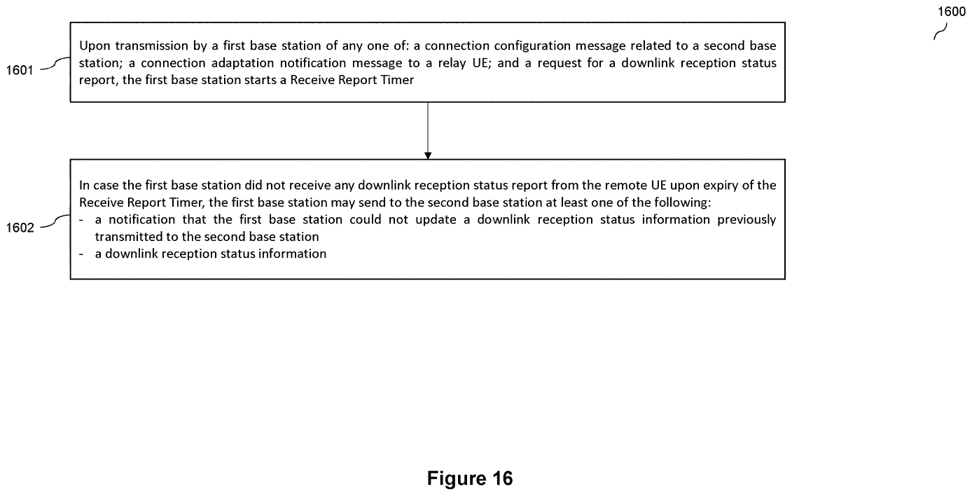

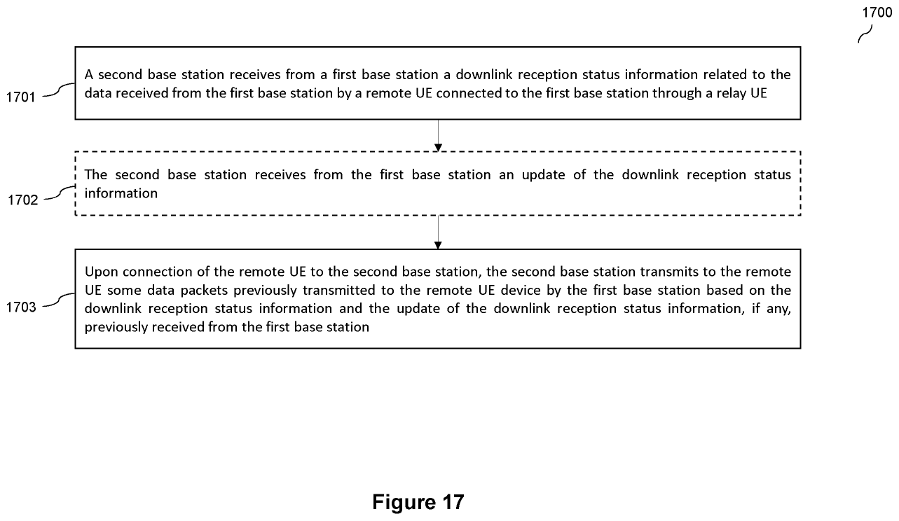

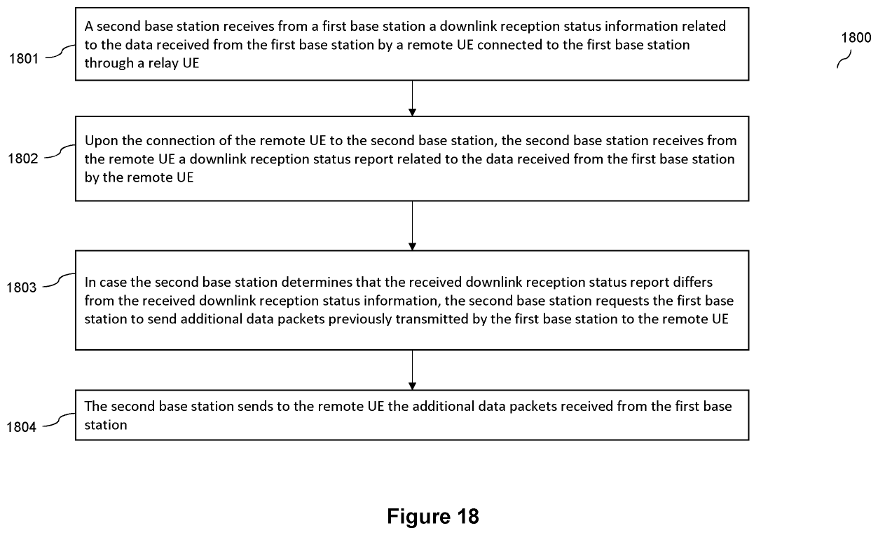

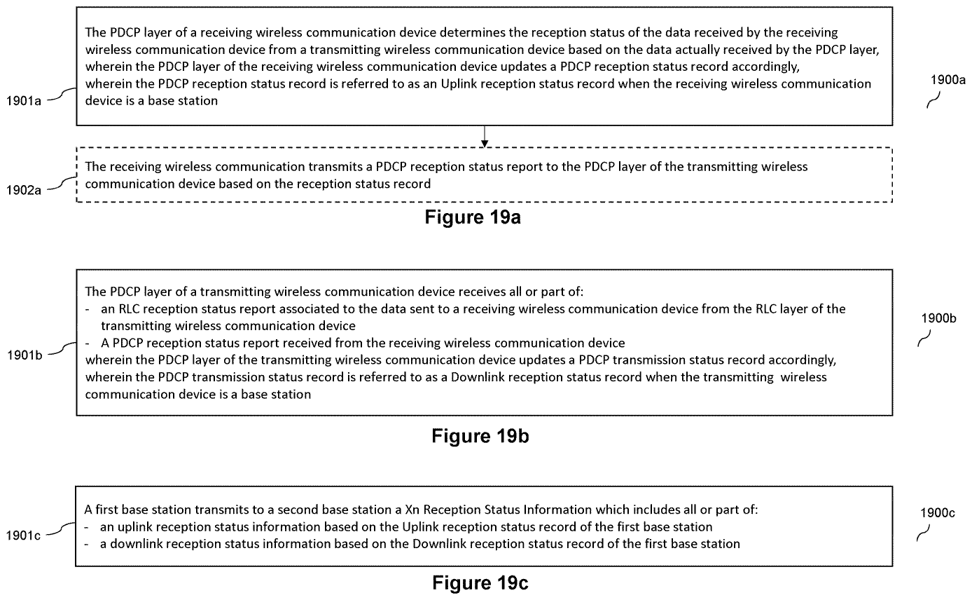

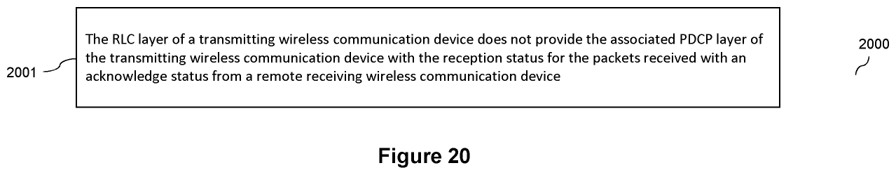

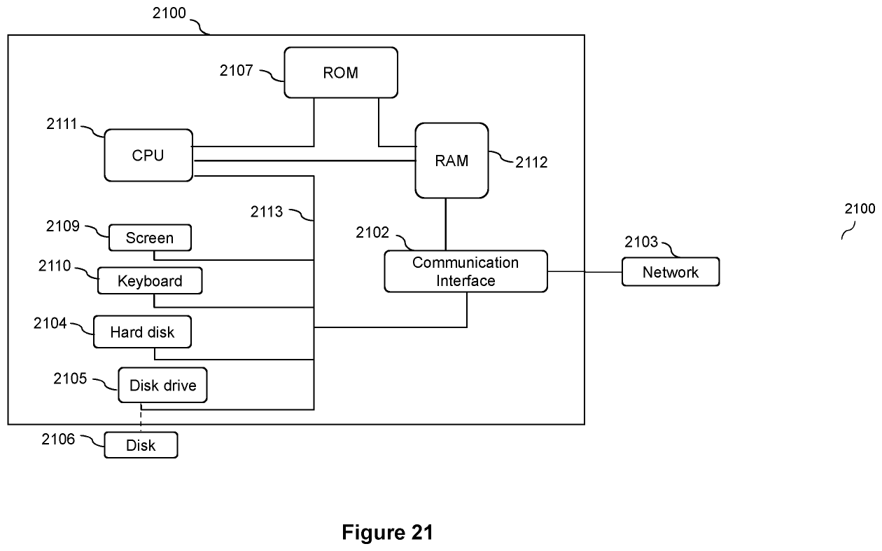

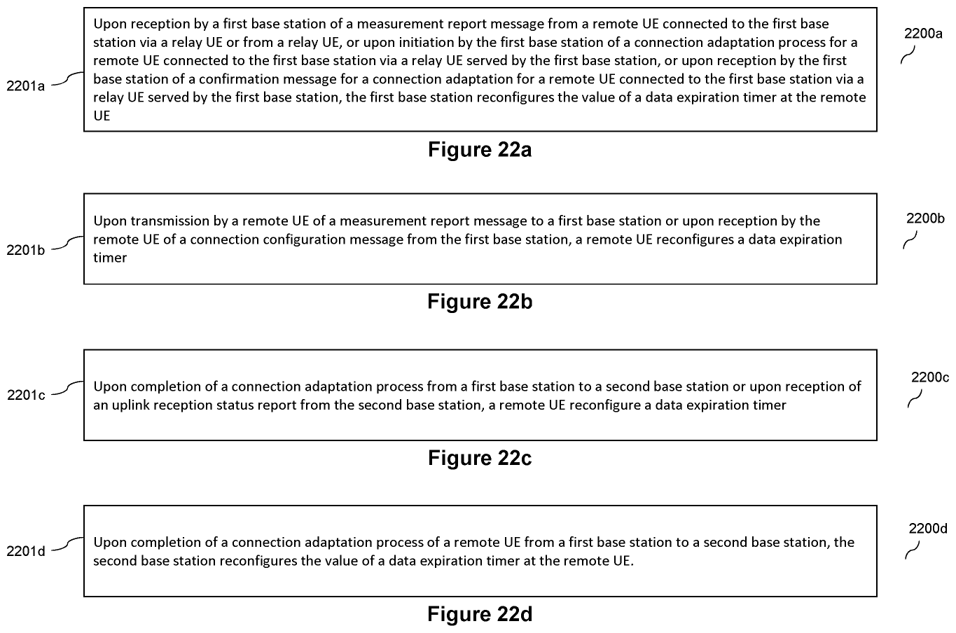

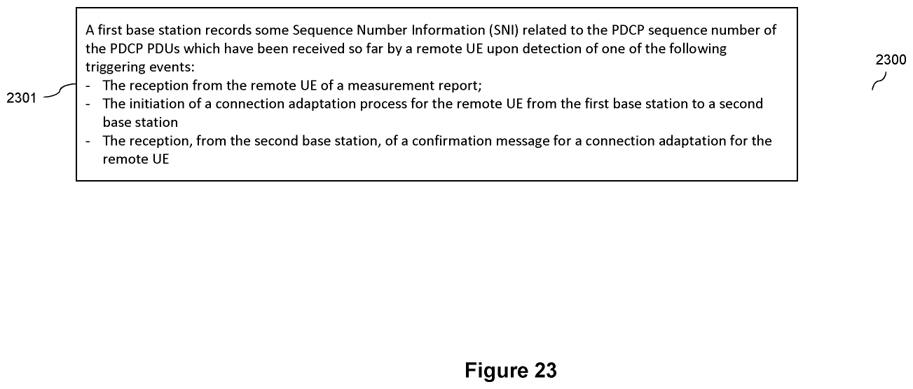

FIG. 13 is a flowchart of an example method for managing, by a remote UE, the sharing of a data reception status with a first base station or a second base station according to one or more embodiments of the present invention.

For example, with reference to the wireless communication system shown in and described with respect to FIG. 1, the remote UE performing the method 1300 of FIG. 13 may be the remote UE 112, while the considered first base station and second base station are respectively the source base station 101 and the target base station 102 and the considered relay UE is the relay UE 110.

The method 1300 as shown in and described with respect to FIG. 13, may be performed by software elements and/or hardware elements. The remote UE node may be implemented in a communication device 2100 as shown in and described with reference to FIG. 21 with the method as shown in and described with respect to FIG. 13 being performed by one or more processing units, such as the central processing unit 2111.

In a step 1301, a remote UE connected to a first base station through a relay UE receives at least one of the following triggering messages:
a connection configuration message related to a second base station, received from the first base station;
a connection adaptation notification message, received from the relay UE;
a request for a Downlink reception status report, received from the first base station, as discussed in method 1200 of FIG. 12.

According to one aspect of the invention, the remote UE only receives from the first base station a connection configuration message related to a second base station.

According to another aspect of the invention, the remote UE receives from the first base station a connection configuration message related to a second base station and a request for a Downlink reception status report.

According to one aspect of the invention, the aforementioned connection configuration message received from the first base station is the CONNECTION CONFIGURATION message 523b, as further described in FIG. 5.

According to one aspect of the invention, the aforementioned connection adaptation notification message received from the relay UE is the CONNECTION ADAPTATION NOTIFICATION message 524 as further described in FIG. 5.

According to one aspect of the invention, the aforementioned reception status request message received from the first base station is the DL RECEPTION STATUS REQUEST message 651, as further described in FIG. 6.

In a step 1302, the reception of one of the triggering messages considered in step 1301 may trigger the transmission, by the remote UE, of a Downlink reception status report.

According to one aspect of the invention, the reception from the first base station of a connection configuration message related to a second base station may trigger the transmission by the remote UE of a Downlink reception status report.

According to another aspect of the invention, the reception from the first base station of a connection configuration message related to a second base station may not trigger the transmission by the remote UE of a Downlink reception status report. In such cases, the reception from the first base station of a request for a Downlink reception status report may instead trigger the transmission by the remote UE of a Downlink reception status report.

According to one aspect of the invention, the Downlink reception status report is sent to the first base station through the DL RECEPTION STATUS REPORT message 650b.

According to another aspect of the invention, the Downlink reception status report is sent to the second base station through the DL RECEPTION STATUS REPORT message 750b once the remote UE connected to the second base station.

In other words, the request for a Downlink reception status report may be implicitly inferred by the remote UE through the reception of a connection configuration message or a connection adaptation notification, or explicitly signalled to the remote UE through the reception of a request for a Downlink reception status report (as discussed in step 1301).

The implicit approach may limit the message exchanges over the air interface, as well as the processing load at both first base station and remote UE. The explicit approach, even though adding some more signalling over the air interface, may allow the first base station to better control the timing of transmission of the Downlink reception status report by the remote UE.

FIG. 14a is a flowchart of an example method for managing, by a remote UE, the sharing of a data reception status with a first base station to which the remote UE may be connected through a relay UE, according to one or more embodiments of the present invention.

For example, with reference to the wireless communication system shown in and described with respect to FIG. 1, the remote UE performing the method 1400a of FIG. 14a may be the remote UE 112, while the considered first base station is the source base station 101 and the considered relay UE is the relay UE 110.

The method 1400a as shown in and described with respect to FIG. 14a, may be performed by software elements and/or hardware elements. The remote UE node may be implemented in a communication device 2100 as shown in and described with reference to FIG. 21 with the method as shown in and described with respect to FIG. 14a being performed by one or more processing units, such as the central processing unit 2111.

In a step 1401a, a remote UE connected to a first base station through a relay UE may send a downlink reception status report to the first base station when transmitting a measurement report to the first base station.

In one aspect of the invention, the remote UE may check the link quality level, or the signal strength, of its surrounding cells and determine the likelihood of a path switch to happen and send a Downlink reception status report to the first base station if said likelihood increases.

This would allow the first base station to have an up-to-date status on the actual reception status at the remote UE PDCP layer when a path adaptation, such as a path switch, is about to occur for the remote UE, which would thus help mitigating the lossy data delivery issue discussed in FIG. 3.

The remote UE may thus send a Downlink reception status report to the first base station along with the transmission of a measurement report to the first base station if one of the following conditions is met:
The link quality level, or the signal strength, of a surrounding cell is greater or equal to some predefined threshold or if the link quality level,
The signal strength, of a surrounding cell is greater from a predefined offset threshold than the link quality level, or the signal strength, of the cell to which the remote UE is connected.

In one aspect of the invention, said surrounding cell belongs to a second base station which is different from the first base station currently serving the remote UE.

According to one embodiment of the invention, link quality level, or the signal strength, measurements considered for connection adaptation decision include all or part of the following metrics: Reference Signal Received Power (RSRP), which provides a measure of the received power of the strongest reference signal from the considered cell; Reference Signal Received Quality (RSRQ), which provides a measure of the quality of the received reference signal from the considered cell, relative to the interference level in the cell; Signal-to-Noise Ratio (SNR), which provides a measure of the signal quality relative to the noise level in the cell and can be used to determine the strength of the signal from the considered cell; Channel Quality Indicator (CQI), which provides a measure of the quality of a received signal. In addition to the aforementioned metrics, other measurements such as cell identity, beamforming quality, and channel state information may also be considered for link quality level, or signal strength measurement.

According to one aspect of the invention, the Downlink reception status report is sent to the first base station through the DL RECEPTION STATUS REPORT message 650a described in relation with FIG. 6, along with the MEASUREMENT REPORT message 511a described in FIG. 5.

According to another aspect of the invention, the Downlink reception status report, or some information extracted from the Downlink reception status report, is sent to the first base station through the MEASUREMENT REPORT message 511a described in FIG. 5.

FIG. 14b is a flowchart of an example method for managing, by a remote UE, the sharing of a data reception status with a first base station to which the remote UE may be connected through a relay UE, according to one or more embodiments of the present invention.

For example, with reference to the wireless communication system shown in and described with respect to FIG. 1, the remote UE performing the method 1400b of FIG. 14b may be the remote UE 112, while the considered first base station is the source base station 101 and the considered relay UE is the relay UE 110.

The method 1400b as shown in and described with respect to FIG. 14b, may be performed by software elements and/or hardware elements. The remote UE node may be implemented in a communication device 2100 as shown in and described with reference to FIG. 21 with the method as shown in and described with respect to FIG. 14b being performed by one or more processing units, such as the central processing unit 2111.

In a step 1401b, a remote UE connected to a first base station through a relay UE may send a downlink reception status report to the first base station on a periodic basis. This would allow the first base station to have regular update on the actual reception status at the remote UE PDCP layer, which would thus help mitigating the lossy data delivery issue discussed in FIG. 3.

According to one aspect of the invention, the periodicity of the sending of the Downlink reception status report to the first base station by the remote UE (i.e. the length of time between the transmission of successive reports) may be configured at the remote UE by the first base station.

FIG. 15 is a flowchart of an example method for managing, by a first base station, the sharing of a data reception status with a second base station, according to one or more embodiments of the present invention.

For example, with reference to the wireless communication system shown in and described with respect to FIG. 1, the first base station performing the method 1500 of FIG. 15 may be the source base station 101, while the considered second base station is the target base station 102 and the considered remote UE and relay UE are respectively the remote UE 112 the relay UE 110.

The method 1500 as shown in and described with respect to FIG. 15, may be performed by software elements and/or hardware elements. The base station may be implemented in a communication device 2100 as shown in and described with reference to FIG. 21 with the method as shown in and described with respect to FIG. 15 being performed by one or more processing units, such as the central processing unit 2111.

In a step 1501, a first base station may receive, from a remote UE connected to the first base station through a relay UE, a Downlink reception status report through any one of the DL RECEPTION STATUS REPORT 650a and DL RECEPTION STATUS REPORT 650b as further described in FIG. 6.

Upon reception of the Downlink reception status report, the first base station may update a Downlink reception status record as defined in method 1900b of FIG. 19b.

According to one aspect of the invention, upon reception of Downlink reception status report from the remote UE, the first base station may also transmit to a second base station all or part of the following:
a Downlink reception status information, as discussed in method 1900c of FIG. 19c. The Downlink reception status information may be sent to the second base station through the Xn RECEPTION STATUS INFORMATION message 640 as described in FIG. 6, or the Xn RECEPTION STATUS INFORMATION message 740 as described in FIG. 7.
an update of a Downlink reception status information previously transmitted to the second base station. The update of a Downlink reception status information may be sent to the second base station through the Xn RECEPTION STATUS UPDATE message 642 as described in FIG. 6.

In one aspect of the invention, the first base station may also transmit all or part of the packet data, or PDCP Protocol Data Units (PDU), which sequence number (SN) is associated to the Downlink reception status information along with the Xn RECEPTION STATUS INFORMATION 640 or 740 or the Xn RECEPTION STATUS UPDATE message 642 (see also the Forward DL Data 641, resp. 741, described in FIG. 6, resp. FIG. 7).

According to one aspect of the invention, the first base station may have negotiated with the second base station a connection adaptation for the considered remote UE and may have received from the second base station a confirmation message such as the CONNECTION ADAPTATION ACK message 522, which is further described in FIG. 5, before sending the Downlink reception status information or the update of the Downlink reception status information to the second base station.

In other words, the first base station may wait for the reception of a Downlink reception status report from the remote UE before sending a Downlink reception status information to the second base station, which allows the first base station to provide the most up-to-date version of the Downlink reception status information. The first base station may also provide the second base station with a first Downlink reception status information in advance, as described in method 1200 of FIG. 12, and later provide the second base station with an updated version of the Downlink reception status information. This allows the second base station to prepare in advance the retransmission of some data packets associated to the first Downlink reception status information and thus optimize the processing at the second base station.

FIG. 16 is a flowchart of an example method for managing, by a first base station, the sharing of a data reception status with a second base station, according to one or more embodiments of the present invention.

For example, with reference to the wireless communication system shown in and described with respect to FIG. 1, the first base station performing the method 1600 of FIG. 15 may be the source base station 101, while the considered second base station is the target base station 102 and the considered remote UE and relay UE are respectively the remote UE 112 the relay UE 110.

The method 1600 as shown in and described with respect to FIG. 16, may be performed by software elements and/or hardware elements. The base station may be implemented in a communication device 2100 as shown in and described with reference to FIG. 21 with the method as shown in and described with respect to FIG. 16 being performed by one or more processing units, such as the central processing unit 2111.

In a step 1601, a first base station may start a Receive Report Timer in response to any one of the following events:
the first base station transmits a remote UE a connection configuration message associated to a second base station;
the first base station transmits a relay UE connecting the remote UE to the first base station a connection adaptation notification message;
a request for a Downlink reception status report, transmitted by the first base station, as discussed in method 1200 of FIG. 12.

According to one aspect of the invention, the aforementioned configuration message sent by the first base station to the remote UE is the CONNECTION CONFIGURATION message 523b, as further described in FIG. 5 and the associated Receive Report Timer is Timer 690b, as further described in FIG. 6.

According to one aspect of the invention, the aforementioned configuration message sent by the first base station to the relay UE is the CONNECTION CONFIGURATION message 523a, as further described in FIG. 5 and the associated Receive Report Timer is Timer 690c, as further described in FIG. 6.

According to one aspect of the invention, the request for a Downlink reception status report is transmitted by the first base station through a DL RECEPTION STATUS REQUEST message 651, as further described in FIG. 6 and the associated Receive Report Timer is Timer 690a, as further described in FIG. 6.

Then in a step 1602, in case the first base station did not receive from the remote UE any Downlink reception status report, for instance through a DL RECEPTION STATUS REPORT message 650b further described in FIG. 6, upon expiry of the Receive Report Timer, the first base station may transmit to the second base station all or part of the following:
a notification that the first base station could not update a Downlink reception status information previously transmitted to the second base station, as discussed in method 1900b of FIG. 19b. This notification may be sent through the Xn RECEPTION STATUS UPDATE FAILURE message 643, as further described in FIG. 6;
a Downlink reception status information, which may be sent to the second base station through the Xn RECEPTION STATUS INFORMATION message 640 as described in FIG. 6.

In one aspect of the invention, the first base station only transmits the notification that the first base station could not update a Downlink reception status information previously transmitted to the second base station.

In one aspect of the invention, the first base station may also transmit all or part of the packet data, or PDCP Protocol Data Units (PDU), which sequence number (SN) is associated to the Downlink reception status information along with the Xn RECEPTION STATUS INFORMATION 640 (see also the Forward DL Data 641 described in FIG. 6).

In one aspect of the invention the notification that the first base station could not update a Downlink reception status information and the Downlink reception status information may be sent through one same message, which may be for instance the Xn RECEPTION STATUS INFORMATION message 640.

In other words, in one aspect of the invention, the first base station may rely upon a simple timer mechanism, the start of which is triggered by the reception of a connection configuration message or a connection adaptation notification or a reception status request message (step 1601) to detect the non-reception of a Downlink reception status report. Indeed, as either the PC5 link between the remote UE and the relay UE or the Uu link between the relay UE and the first base station is weak enough for causing the first base station to perform remote UE connection adaptation (i.e., remote UE path switching or relay UE handover), the first base station may not receive the Downlink reception status report at all, or may receive it after a significant time resulting from multiple retransmissions. It is therefore advantageous to monitor the actual reception of the Downlink reception status report, so as to be in a position of further informing the second base station that it should rely on the last received Downlink reception status information transmitted according to method 1500 of FIG. 15, as the first base station was not able to update it with more up-to-date information. In one aspect of the invention, the first base station may send again the Downlink reception status information that was last received by the second base station to prevent any ambiguity on the data packets to be further retransmitted by the second base station.

FIG. 17 is a flowchart of an example method for managing, by a second base station, the retransmission of missing data initially sent by a first base station through a relay UE to a remote UE according to one or more embodiments of the present invention.

For example, with reference to the wireless communication system shown in and described with respect to FIG. 1, the second base station performing the method 1700 of FIG. 17 may be the target base station 102, while the considered first base station may be the source base station 101 and the considered remote UE and relay UE may be respectively the remote UE 112 and the relay UE 110.

The method 1700 as shown in and described with respect to FIG. 17, may be performed by software elements and/or hardware elements. The base station may be implemented in a communication device 2100 as shown in and described with reference to FIG. 21 with the method as shown in and described with respect to FIG. 17 being performed by one or more processing units, such as the central processing unit 2111.

In a step 1701, a second base station receives from a first base station a Downlink reception status information related to the data received from the first base station by a remote UE connected to the first base station through a relay UE, as discussed in method 1900c of FIG. 19c.

According to one aspect of the invention, the Downlink reception status information may be received through the Xn RECEPTION STATUS INFORMATION message 640 as described in FIG. 6.

In one aspect of the invention, the second base station may also receive from the first base station along with the Downlink reception status information all or part of the packet data, or PDCP Protocol Data Units (PDU), which sequence number (SN) is associated to the Downlink reception status information (see also the Forward DL Data 641 described in FIG. 6).

In a second step 1702, the second base station may receive from the first base station an update of the Downlink reception status information, through the Xn RECEPTION STATUS UPDATE message 642 as described in FIG. 6. In one aspect of the invention, the second base station may also receive from the first base station, along with the update of the Downlink reception status information, all or part of the packet data, or PDCP Protocol Data Units (PDU), which sequence number (SN) is associated to the update of the Downlink reception status information (see also the Forward DL Data 641 described in FIG. 6).

In one aspect of the invention, the second base station may not receive any update of Downlink reception status information in case the Downlink reception status information received in step 1701 was sent by the first base station upon reception by the first base station of Downlink reception status report from the remote UE, as described in method 1500 of FIG. 15.

Then, in a step 1703, once the connection of the remote UE to the second base station has completed, for instance upon reception by the second base station of a CONNECTION ADAPTATION COMPLETE message 525 as described in FIG. 5, the second base station may transmit to the remote UE some data packets, or PDCP Protocol Data Units (PDU), previously transmitted to the remote UE device by the first base station based on the Downlink reception status information and the update of the Downlink reception status information, if any, previously received from the first base station.

In one aspect of the invention, the second base station may transmit to the remote UE all or part of the data packets, or PDCP Protocol Data Units (PDU), received from the first base station in step 1701 and/in step 1702.

FIG. 18 is a flowchart of an example method for managing, by a second base station, the retransmission of missing data initially sent by a first base station through a relay UE to a remote UE according to one or more embodiments of the present invention.

For example, with reference to the wireless communication system shown in and described with respect to FIG. 1, the second base station performing the method 1800 of FIG. 18 may be the target base station 102, while the considered first base station may be the source base station 101 and the considered remote UE and relay UE may be respectively the remote UE 112 and the relay UE 110.

The method 1800 as shown in and described with respect to FIG. 18, may be performed by software elements and/or hardware elements. The base station may be implemented in a communication device 2100 as shown in and described with reference to FIG. 21 with the method as shown in and described with respect to FIG. 18 being performed by one or more processing units, such as the central processing unit 2111.

In a step 1801, a second base station may receive from a first base station a Downlink reception status information related to the data received from the first base station by a remote UE connected to the first base station through a relay UE.

According to one aspect of the invention, the Downlink reception status information may be received through the Xn RECEPTION STATUS INFORMATION message 740 as described in FIG. 7.

In one aspect of the invention, the second base station may also receive from the first base station along with the Downlink reception status information all or part of the packet data, or PDCP Protocol Data Units (PDU), which sequence number (SN) is associated to the Downlink reception status information (see also the Forward DL Data 741 described in FIG. 7).

Then, in step 1802, once the connection of the remote UE to the second base station has completed, for instance upon reception by the second base station of a CONNECTION ADAPTATION COMPLETE message 525 as described in FIG. 5, the second base station may receive from the remote UE a Downlink reception status report, for instance through the DL RECEPTION STATUS REPORT 750b, related to the data received from the first base station by the remote UE, as discussed in method 1900a of FIG. 19a.

Then, in step 1803, the second base station may compare the information embedded in the Downlink reception status report received from the remote UE in step 1802 to the Downlink reception status information received from the first base station in step 1801.

In one aspect of the invention, in case the second base station determines that the information embedded in the Downlink reception status report received in step 1802 differs from the Downlink reception status information received in step 1801, the second base station may request, for instance through the sending of an Xn RECEPTION STATUS UPDATE FAILURE message 742, the first base station to send some additional data packets, or PDCP Protocol Data Units (PDU), previously transmitted by the first base station to the remote UE.

The Downlink reception status report received in step 1802 differs from the Downlink reception status information received in step 1801 if some sequence numbers (SN) associated to the Downlink reception status report received in step 1802 are not part of the Downlink reception status information received in step 1801.

In one aspect of the invention, the additional data packets, or PDCP Protocol Data Units (PDU), requested by the second base station to the first base station are all or part of the data packets, or PDCP Protocol Data Units (PDU), associated to the sequence numbers (SN) associated to the Downlink reception status report received in step 1802 which are not part of the Downlink reception status information received in step 1801.

Then, in step 1804, the second base station may receive from the first station the additional data packets, or PDCP Protocol Data Units (PDU), requested in step 1803 to the first base station (see also Forward Missing DL Data 743) and transmit all or part of these additional data packets, or PDCP Protocol Data Units (PDU), to the remote UE (see also the DL User Data 712 described in FIG. 7).

Referring now also to FIG. 5 which is a schematic and simplified diagram illustrating example message flows for managing the lossless data delivery when performing remote UE communication adaptation, such as inter-gNB path switch from an indirect path, in accordance with one or more embodiments of the invention.

In one example, a remote UE, such as remote UE 112, is connected to a first base station, such as base station 101, through a relay UE 110, and transmits uplink data, or UL User Data 510, to the first base station through the relay UE.

The remote UE and the relay UE may also send to the first base station one or more measurement report through, respectively, the MEASUREMENT REPORT messages 511a and 511b.

According to one aspect of the invention, the MEASUREMENT REPORT message 511a and 511b are the MeasurementReport message defined in 3GPP TS 38.331.

Based on the information carried by the received MeasurementReport messages, the first base station may decide to adapt the connection of the remote UE to the network (step 520a).

In one aspect of the invention, upon reception of the MEASUREMENT REPORT message 511a or 511b, the first base station may decide to reconfigure a data expiration timer at the remote UE by sending a CONNECTION RECONFIGURATION message 526a to the remote UE.

In one aspect of the invention, the CONNECTION RECONFIGURATION message 526a may include all or part of the following:
A new timer value for the Remote UE's data expiration timer. In one example, upon reception of the CONNECTION RECONFIGURATION message 526a, the remote UE may update the current value of its data expiration timer with the new timer value. In one aspect of the invention, the new timer value may be an infinite value.
A timer disable request. In one example, upon reception of the CONNECTION RECONFIGURATION message 526a, the remote UE may pause or reset its current data expiration timer.

In one aspect of the invention, the CONNECTION RECONFIGURATION message 526a is the RRCReconfiguration message defined in 3GPP TS 38.331.

According to one aspect of the invention, the first base station may decide to perform remote UE path switch from the current indirect path that connects the remote UE to the first base station through the relay UE to a second path, which may be direct or indirect, that would connect the remote UE to a second base station, which may be base station 102.

According to another aspect of the invention, the first base station may decide to perform relay UE handover to the second base station 102.

In one aspect of the invention, the first base station may decide to perform remote UE connection adaptation to the second base station 102 if the link quality level, or the signal strength, of a cell served by the second base station 102 reported in the received MEASUREMENT REPORT message 511a or 511b is greater than or equal to some predefined threshold or if the link quality level, or the signal strength, of a cell served by the second base station reported in the received MEASUREMENT REPORT message 511a is greater from a predefined offset threshold than the link quality level, or the signal strength, of the cell to which the remote UE is connected.

According to one embodiment of the invention, link quality level, or the signal strength, measurements considered for connection adaptation decision include all or part of the following metrics: Reference Signal Received Power (RSRP), which provides a measure of the received power of the strongest reference signal from the considered cell; Reference Signal Received Quality (RSRQ), which provides a measure of the quality of the received reference signal from the considered cell, relative to the interference level in the cell; Signal-to-Noise Ratio (SNR), which provides a measure of the signal quality relative to the noise level in the cell and can be used to determine the strength of the signal from the considered cell; Channel Quality Indicator (CQI), which provides a measure of the quality of a received signal. In addition to the aforementioned metrics, other measurements such as cell identity, beamforming quality, and channel state information may also be considered for link quality level, or signal strength measurement.

The first base station may negotiate the remote UE connection adaptation with the second base station by sending a CONNECTION ADAPTATION REQUEST message 521.

In one aspect of the invention, upon transmission of the CONNECTION ADAPTATION REQUEST message 521, the first base station may decide to reconfigure a data expiration timer at the remote UE by sending a CONNECTION RECONFIGURATION message 526b to the remote UE.

In one aspect of the invention, the CONNECTION RECONFIGURATION message 526b may include all or part of the following:
A new timer value for the Remote UE's data expiration timer. In one example, upon reception of the CONNECTION RECONFIGURATION message 526b, the remote UE may update the current value of its data expiration timer with the new timer value. In one aspect of the invention, the new timer value may be an infinite value.
A timer disable request. In one example, upon reception of the CONNECTION RECONFIGURATION message 526b, the remote UE may pause or reset its current data expiration timer.

In one aspect of the invention, the CONNECTION RECONFIGURATION message 526b is the RRCReconfiguration message defined in 3GPP TS 38.331.

In one aspect of the invention, the CONNECTION ADAPTATION REQUEST message 521 is an Xn message, as defined in TS 38.423, used for requesting a path switch for the remote UE. This message may carry information related to the cell ID targeted for path adaptation and/or information related to the identifier of the remote UE or the relay UE and/or information related to some QoS or application requirements for the remote UE. In one aspect of the invention, the CONNECTION ADAPTATION REQUEST message 521 may also be referred to as a PATH SWITCHING REQUEST message 521 or a PATH SWITCH REQUEST message 521.

In one aspect of the invention, the CONNECTION ADAPTATION REQUEST message 521 is the HANDOVER REQUEST message defined in 3GPP TS 38.423.

The second base station may accept the remote UE connection adaptation by sending to the first base station a CONNECTION ADAPTATION ACK message 522.

In one aspect of the invention, upon reception of a CONNECTION ADAPTATION ACK message 522, the first base station may decide to reconfigure a data expiration timer at the remote UE by sending a CONNECTION RECONFIGURATION message 526c to the remote UE.

In one aspect of the invention, the CONNECTION RECONFIGURATION message 526c may include all or part of the following:
A new timer value for the Remote UE's data expiration timer. In one example, upon reception of the CONNECTION RECONFIGURATION message 526c, the remote UE may update the current value of its data expiration timer with the new timer value. In one aspect of the invention, the new timer value may be an infinite value.
A timer disable request. In one example, upon reception of the CONNECTION RECONFIGURATION message 526c, the remote UE may pause or reset its current data expiration timer.

In one aspect of the invention, the CONNECTION RECONFIGURATION message 526c is the RRCReconfiguration message defined in 3GPP TS 38.331.

In one aspect of the invention, the CONNECTION ADAPTATION ACK message 522 is an Xn message, as defined in TS 38.423, used for acknowledging a path switch previously requested for the remote UE. In one aspect of the invention, the CONNECTION ADAPTATION ACK message 522 may also be referred to as a PATH SWITCHING ACKNOWLEDGE message 522.

In one aspect of the invention, the CONNECTION ADAPTATION ACK message 522 is the HANDOVER ACKNOWLEDGE message defined in 3GPP TS 38.423.

In one aspect of the invention, upon reception of a CONNECTION ADAPTATION ACK message 522 at the first base station may perform all or part of the following (step 520b):
the transmission of a CONNECTION CONFIGURATION message 523a to the relay UE. In one aspect of the invention, the CONNECTION CONFIGURATION message 523a is used by the first base station to notify the relay UE that it should perform a handover to the second base station and to provide the relay UE with the corresponding configuration parameters required to perform the handover;
the transmission of a CONNECTION CONFIGURATION message 523b to the remote UE. In one aspect of the invention, the CONNECTION CONFIGURATION message 523b is used by the first base station to notify the relay UE that it should perform a path switch from its current indirect path involving the first base station (i.e., the path that connects the remote UE to the first base station through the relay UE) to a new path involving the second base station. This message may also provide the configuration parameters required to perform the path switching process at the remote UE. Such parameters may include all or part of: the identifier of the second base station, the identifier of a target cell managed by the second base station, the identifier of a new relay UE in case the new path involving the second base station is an indirect path. In one aspect of the invention, this message may also carry the information of the message 526c for the reconfiguration of a data expiration timer at the remote UE. In one aspect of the invention, the CONNECTION CONFIGURATION message 523b may also be referred to as a PATH SWITCHING CONFIGURATION message 523b or PATH SWITCH CONFIGURATION message 523b;

In one aspect of the invention, the CONNECTION CONFIGURATION message 523a is the RRCReconfiguration message defined in 3GPP TS 38.331.

In one aspect of the invention, the CONNECTION CONFIGURATION message 523b is the RRCReconfiguration message defined in 3GPP TS 38.331.

In one aspect of the invention, the reception of a CONNECTION ADAPTATION ACK message 522 at the first base station may trigger all or part of the following (step 520b):
the transmission by the first base station of an UL RECEPTION STATUS REPORT message 550a to the remote UE. In one aspect of the invention, the UL RECEPTION STATUS REPORT message 550a is used by the first base station to provide the remote UE with an Uplink reception status report, as discussed in method 1900a of FIG. 19a.
the transmission by the first base station of an Xn RECEPTION STATUS INFORMATION message 540 to the second base station. In one aspect of the invention, the Xn RECEPTION STATUS INFORMATION message 540 is used by the first base station to provide the source base station with an Uplink reception status information, as discussed in method 1900c of FIG. 19c.

In one aspect of the invention, the Xn RECEPTION STATUS INFORMATION message 540 may include an information related to the current status of the Remote UE's expiration timer. In one example, this information may include all or part of the following timer status information:
A current timer value, which indicates the current value assigned to the Remote UE's expiration timer. In one example, this value may be an infinite value.
A time enable status, which indicates if the remote UE's expiration timer is currently enabled or disabled.

In one aspect of the invention, the first base station may add the aforementioned timer status only if it has previously reconfigured the expiration timer at the remote UE for instance through a CONNECTION RECONFIGURATION message 526a, 526b or 526c.

In one aspect of the invention, the UL RECEPTION STATUS REPORT message 550a refers to the PDCP Control PDU carrying one PDCP status report, as defined in 3GPP TS 38.323.

In aspect of the invention, the reception of a CONNECTION ADAPTATION ACK message 522 at the first base station may trigger the sending of a CONNECTION CONFIGURATION message 523b which carries some PDCP status report information. In such case, the first base station may not send an UL RECEPTION STATUS REPORT message 550a.

In one aspect of the invention, the Xn RECEPTION STATUS INFORMATION message 540 is the SN STATUS TRANSFER message defined in 3GPP TS 38.423.

Upon reception of a CONNECTION CONFIGURATION message 523a from the first base station, the relay UE may notify the remote UE that it will perform a handover by sending a CONNECTION ADAPTATION NOTIFICATION message 524 over its PC5 link with the remote UE. In one aspect of the invention, the CONNECTION ADAPTATION NOTIFICATION message 524 may include some information related to the identifier of the second base station, the identifier of a target cell managed by the second base station, the identifier of a new relay UE in case the new path involving the second base station is an indirect path.

In one example, the CONNECTION ADAPTATION NOTIFICATION message 524 may be the RRCReconfigurationSidelink message defined in TS 38.331.

In one example, the CONNECTION ADAPTATION NOTIFICATION message 524 may be the NotificationMessageSidelink message defined in TS 38.331.

In one aspect of the invention, the transmission of an UL RECEPTION STATUS REPORT message 550a is not triggered by the reception at the first base station of a CONNECTION ADAPTATION ACK message 522. In such case, the reception of a CONNECTION CONFIGURATION message 523a or the reception of a CONNECTION ADAPTATION NOTIFICATION message 524 at the remote UE triggers the transmission by the remote UE of an UL RECEPTION STATUS REQUEST message 551a to request the first base station the transmission of an UL RECEPTION STATUS REPORT message 550a.

In one example, the UL RECEPTION STATUS REQUEST message 551a refers to the PDCP Control PDU, as defined in 3GPP TS 38.323, which header carries an information for requesting the sending of a PDCP status report. In one aspect of the invention, the information for requesting the sending of a PDCP status report is a 1-bit field in the PDCP Control PDU header.

In one example, the UL RECEPTION STATUS REQUEST message 551b refers to the RRCReconfiguration message, as defined in 3GPP TS 38.331, which carries an information for requesting the sending of a PDCP status report.

In one aspect of the invention, upon reception of an UL RECEPTION STATUS REPORT message 550a, the remote UE may update a PDCP transmission status record (step 520c), as discussed in method 1900b of FIG. 19b.

In one aspect of the invention, upon reception of a CONNECTION ADAPTATION NOTIFICATION message 524, the remote UE may start a Transmit Report Timer 590b.

In one aspect of the invention, upon reception of a CONNECTION CONFIGURATION message 523b, the remote UE may start a Transmit Report Timer 590a.

In case the remote UE received a CONNECTION CONFIGURATION message 523b/PATH SWITCHING CONFIGURATION message 523b/PATH SWITCH CONFIGURATION message 523b, the remote UE may perform a path switching from its current indirect path with the first base station to the second base station.

In case the remote UE received a CONNECTION ADAPTATION NOTIFICATION message 524, the remote UE may perform a connection reestablishment to the second base station.

The remote UE may complete the path switching process or the connection reestablishment process by sending to the second base station a CONNECTION ADAPTATION COMPLETE message 525.

In one example, the CONNECTION ADAPTATION COMPLETE message 525 is the RRCReconfigurationComplete message defined in 3GPP TS 38.331.

In one example, the CONNECTION ADAPTATION COMPLETE message 525 is the RRCReestablishment message defined in 3GPP TS 38.331.

In one aspect of the invention, upon reception of a CONNECTION ADAPTATION COMPLETE message 525, the second base station may decide to reconfigure a data expiration timer at the remote UE by sending a CONNECTION RECONFIGURATION message 526d to the remote UE.

In one aspect of the invention, the CONNECTION RECONFIGURATION message 526d may include all or part of the following:
A new timer value for the Remote UE's data expiration timer. In one example, upon reception of the CONNECTION RECONFIGURATION message 526d, the remote UE may update the current value of its data expiration timer with the new timer value.
A timer reset request. In one example, upon reception of the CONNECTION RECONFIGURATION message 526d, the remote UE may reset its data expiration timer to its initial value.
A timer enable request. In one example, upon reception of the CONNECTION RECONFIGURATION message 526d, the remote UE may un-pause or reset its current data expiration timer.

In one aspect of the invention, the CONNECTION RECONFIGURATION message 526d is the RRCReconfiguration message defined in 3GPP TS 38.331. In one aspect of the invention, the CONNECTION ADAPTATION COMPLETE message 525 may include an information related to the current status of the Remote UE's expiration timer. In one example, this information may include all or part of the following information:
A current timer value, which indicates the current value assigned to the Remote UE's expiration timer. In one example, this value may be an infinite value.
A time enable status, which indicates if the remote UE's expiration timer is currently enabled or disabled.

In case the remote UE did not receive the UL RECEPTION STATUS REPORT message 550a from the first base station upon expiry of either the Transmit Report Timer 590a or the Transmit Report Timer 590b, the remote UE may request the second base station to send an UL RECEPTION STATUS REPORT message 550b by transmitting to the second base station an UL RECEPTION STATUS REQUEST message 551b.

In one aspect of the invention, the UL RECEPTION STATUS REPORT message 550b is used by the first base station to provide the remote UE with an Uplink reception status report, as discussed in method 1900a of FIG. 19a.

In one example, the UL RECEPTION STATUS REQUEST message 551b refers to the PDCP Control PDU, as defined in 3GPP TS 38.323, which header carries an information for requesting the sending of a PDCP status report. In one aspect of the invention, the information for requesting the sending of a PDCP status report is a 1-bit field in the PDCP Control PDU header.

In one example, the UL RECEPTION STATUS REQUEST message 551b refers to the RRCReconfiguration message, as defined in 3GPP TS 38.331, which carries an information for informing the second base station of a missing PDCP status report from the previous cell and requesting the sending of a PDCP status report.

In one example, the UL RECEPTION STATUS REPORT message 550b refers to the PDCP Control PDU carrying one PDCP status report, as defined in 3GPP TS 38.323.

In one aspect of the invention, upon reception of an UL RECEPTION STATUS REPORT message 550b, the remote UE may update a PDCP transmission status record (step 520d), as discussed in method 1900b of FIG. 19b.

Upon reception of a RECEPTION STATUS REPORT message 550b following an UL RECEPTION STATUS REQUEST message 551b, or upon transmission of a CONNECTION ADAPTATION COMPLETE message 525 in case no UL RECEPTION STATUS REQUEST message 551b was sent to the second base station, the remote UE transmits to the second base station the data packets, or PDCP Protocol Data Units (PDU), which have not been received by the first base station, based on the information in its last updated PDCP transmission status record, i.e., the remote UE transmits to the second base station the data packets, or PDCP Protocol Data Units (PDU), which have not been received by the first base station based on the information carried by the received UL RECEPTION STATUS REPORT message 550a or 550b.

Referring now also to FIG. 6, a remote UE may send, along with measurement MEASUREMENT REPORT message 511a, a Downlink reception status report, as discussed in method 1900a of FIG. 19a, through a DL RECEPTION STATUS REPORT message 650a to the first base station.

In one example, the DL RECEPTION STATUS REPORT message 650a refers to the PDCP Control PDU carrying one PDCP status report, as defined in 3GPP TS 38.323.

In one aspect of the invention, still referring to FIG. 6, a remote UE may send, through measurement MEASUREMENT REPORT message 511a, information related to a Downlink reception status report, as discussed in method 1900a of FIG. 19a to the first base station.

Now referring to FIG. 6 of FIG. 7, in one aspect of the invention, the reception of a CONNECTION ADAPTATION ACK message 522 at the first base station may trigger all or part of the following:
transmission of a request for a Downlink reception status by the first base station to the remote UE, through the DL RECEPTION STATUS REQUEST message 651 or 751.
Transmission of a Downlink reception status information by the first base station to the second base station, through the Xn RECEPTION STATUS INFORMATION message 640 or 740. In one aspect of the invention, the first base station may also transmit all or part of the packet data, or PDCP Protocol Data Units (PDU), which sequence number (SN) is associated to the Downlink reception status information carried in the Xn RECEPTION STATUS INFORMATION message 640, resp. 740, through the DL Data 641, resp. 741.

In one aspect of the invention, the transmission of a DL RECEPTION STATUS REQUEST message 651 or 751 may be performed before sending a CONNECTION CONFIGURATION message 523a or 523b to the remote UE.

In one aspect of the invention, the transmission of a DL RECEPTION STATUS REQUEST message 651 or 751 may be performed after sending a CONNECTION CONFIGURATION message 523a or 523b to the remote UE.

In one aspect of the invention, the Xn RECEPTION STATUS INFORMATION message 640 or 740 is the SN STATUS TRANSFER message defined in 3GPP TS 38.423.

In one example, the DL RECEPTION STATUS REQUEST message 651 refers to the PDCP Control PDU, as defined in 3GPP TS 38.323, which header carries an information for requesting the sending of a PDCP status report. In one aspect of the invention, the information for requesting the sending of a PDCP status report is a 1-bit field in the PDCP Control PDU header.

In one example, the DL RECEPTION STATUS REQUEST message 651 refers to the RRCReconfiguration message, as defined in 3GPP TS 38.331, which carries an information for requesting the sending of a PDCP status report.

In one aspect of the invention, the Xn RECEPTION STATUS INFORMATION message 540 is the SN STATUS TRANSFER message defined in 3GPP TS 38.423.

Referring now to FIG. 6, in one aspect of the invention, upon transmission of a CONNECTION CONFIGURATION message 523a, the remote UE may start a Receive Report Timer 690c.

Still referring to FIG. 6, in one aspect of the invention, upon transmission of a CONNECTION CONFIGURATION message 523b, the remote UE may start a Receive Report Timer 690b.

In one aspect of the invention, upon reception of a CONNECTION CONFIGURATION message 523b, the remote UE may start a Receive Report Timer 690a.

Referring to FIG. 6, the reception of any one of a CONNECTION ADAPTATION NOTIFICATION message 524 or a CONNECTION CONFIGURATION message 523b or a DL RECEPTION STATUS REQUEST message 651, may trigger at the remote UE (step 620b) the sending of a Downlink reception status report, as discussed in method 1900a of FIG. 19a, through the DL RECEPTION STATUS REPORT message 650b to the first base station.

Referring to FIG. 7, the reception of any one of a CONNECTION ADAPTATION NOTIFICATION message 524 or a CONNECTION CONFIGURATION message 523b or a DL RECEPTION STATUS REQUEST message 751, may trigger at the remote UE (step 720b) the sending of a Downlink reception status report, as discussed in method 1900a of FIG. 19a, through the DL RECEPTION STATUS REPORT message 750b to the first base station.

In one example, the DL RECEPTION STATUS REPORT message 650b or 750b refers to the PDCP Control PDU carrying one PDCP status report, as defined in 3GPP TS 38.323.

Referring back to FIG. 6, upon reception of a DL RECEPTION STATUS REPORT message 650b from the remote UE, the first base station may update a Downlink reception status record (step 620c), as discussed in method 1900b of FIG. 19b.

Still referring to FIG. 6, the reception of a DL RECEPTION STATUS REPORT message 650b from the remote UE may also trigger at the first base station one of the following:
the transmission of a Downlink reception status information, as discussed in method 1900c of FIG. 19c, to the second base station through the Xn RECEPTION STATUS INFORMATION message 640. In one aspect of the invention, the first base station may also transmit all or part of the packet data, or PDCP Protocol Data Units (PDU), which sequence number (SN) is associated to the Downlink reception status information carried in the Xn RECEPTION STATUS INFORMATION message 640 through the DL Data 641.
the transmission to the second base station of an update of a Downlink reception status information (as discussed in method 1900c of FIG. 19c) previously transmitted to the second base station through the Xn RECEPTION STATUS UPDATE message 642. In one aspect of the invention, the first base station may also transmit all or part of the packet data, or PDCP Protocol Data Units (PDU), which sequence number (SN) is associated to the Downlink reception status information carried in the Xn RECEPTION STATUS UPDATE message 642 through the DL Data 641.

Still in relation with FIG. 6, in case the remote UE did not receive the DL RECEPTION STATUS REPORT message 650b from the first base station upon expiry of either the Receive Report Timer 690a or the Receive Report Timer 690b, or the Receive Report Timer 690c, the first base station may send to the second base station an Xn RECEPTION STATUS UPDATE FAILURE message 643 to inform the second base station that the first base station did not receive any Downlink reception status report from the remote UE since the remote UE connection adaptation was initiated and, as a consequence, could not update the Downlink reception status information sent in a previous the Xn RECEPTION STATUS INFORMATION message 640.

In one example, the Xn RECEPTION STATUS UPDATE FAILURE message 643 is the EARLY STATUS TRANSFER message, as defined in 3GPP TS 38.423.

In one aspect of the invention, the first base station may send again the last Xn RECEPTION STATUS INFORMATION message 640 previously sent to the second base station. The first base station may also transmit again all or part of the packet data, or PDCP Protocol Data Units (PDU), which sequence number (SN) is associated to the last Xn RECEPTION STATUS INFORMATION message 640 through the DL Data 641.

Still in relation with FIG. 6, the second base station may send to the remote UE all or part of the data packets, or PDCP Protocol Data Units (PDU), received from the first base station along with an Xn RECEPTION STATUS INFORMATION message 640 and/or an Xn RECEPTION STATUS UPDATE message 642 through some DL Data 641, through the DL User Data 612.

Now referring to FIG. 7, upon reception of a DL RECEPTION STATUS REPORT message 750b from the remote UE, the second base station may determine that the information embedded in the Downlink reception status report received in the DL RECEPTION STATUS REPORT message 750b differs from the Downlink reception status information received in from the last-received Xn RECEPTION STATUS INFORMATION message 740.

In such case, the second base station may request, through the sending of an Xn RECEPTION STATUS UPDATE FAILURE message 742, the first base station to send some additional data packets, or PDCP Protocol Data Units (PDU), previously transmitted by the first base station to the remote UE, wherein the sequence number (SN) of the requested packets corresponds to the difference between the information in the DL RECEPTION STATUS REPORT message 750b and the information in the last-received Xn RECEPTION STATUS INFORMATION message 740.

In one aspect of the invention, the Xn RECEPTION STATUS UPDATE FAILURE message 742 may include all or part of:
Some information related to the information carried in the DL RECEPTION STATUS REPORT message 750b;
Some information related to the difference between the information in the DL RECEPTION STATUS REPORT message 750b and the information in the last-received Xn RECEPTION STATUS INFORMATION message 740;

In one aspect of the invention, the information carried in the Xn RECEPTION STATUS UPDATE FAILURE message 742 may include all or part of: a bitmap, or a list of sequence number(s).

In one example, the Xn RECEPTION STATUS UPDATE FAILURE message 742 is an Xn message as discussed in TS 38.423.

In one example, the Xn RECEPTION STATUS UPDATE FAILURE message 742 is the ERROR INDICATION or a FAILURE INDICATION message as discussed in TS 38.423.

Upon reception from the first base station of the requested additional data packets, or PDCP Protocol Data Units (PDU) through the Forward Missing DL Data 743, the second base station may transmit all or part of these additional data packets, or PDCP Protocol Data Units (PDU), to the remote UE through the DL User Data 712.

FIG. 21 shows a schematic representation of an example communication device or station, in accordance with one or more example embodiments of the present disclosure.

The communication device 2100 may be a device such as a micro-computer, a workstation or a light portable device. The communication device 2100 comprises a communication bus 2113 to which there are preferably connected:
a central processing unit 2111, such as a microprocessor, denoted CPU;
memory for storing data and computer programs containing instructions for the operation of the communication device 2100. The computer programs may contain a number of different program elements or sub-routines containing instructions for a variety of operations and for implementing the invention. For example, the program elements include at least one element for managing handover of a relay UE as discussed above. The at least one element when executed by the central processing unit 2111 configure the processing unit (and hence the communication device 2100) to perform the method(s) as described above.

The communication device 2100 may further comprise at least one communication interface 2102 connected to the radio communication network 2103 over which digital data packets or frames or control frames are transmitted, for example a wireless communication network according to the Release 16 for 5G NR. The frames are written from a FIFO sending memory in RAM 2112 to the communication interface 2102 for transmission or are read from the communication interface 2102 for reception and writing into a FIFO receiving memory in RAM 2112 under the control of a software application running in the CPU 2111.

Each of a UE and base station may comprise such a communication device 2100.

The central processing unit 2111 may be a single processing unit or processor or may comprise two or more processing units or processors carrying out the processing required for the operation of the communication device 2100. The number of processing units or processors and the allocation of processing functions to the processing unit(s) is a matter of design choice for a skilled person.

The memory may include:
a read only memory 2107, denoted ROM, for storing computer programs for implementing methods according to embodiments of the invention;
a random-access memory 2112, denoted RAM, for storing the executable code of methods according to embodiments of the invention as well as the registers adapted to record variables and parameters necessary for implementing methods according to embodiments of the invention.

Optionally, the communication device 2100 may also include the following components:
a data storage means 2104 such as a hard disk, for storing computer programs for implementing methods according to one or more embodiments of the invention;
a disk drive 2105 for a disk 2106, the disk drive being adapted to read data from the disk 2106 or to write data onto said disk;
a screen 2109 for displaying decoded data and/or serving as a graphical interface with the user, by means of a keyboard 2110 or any other user input means.

Preferably the communication bus 2113 provides communication and interoperability between the various elements included in the communication device 2100 or connected to it. The representation of the bus 2113 is not limiting and in particular, the central processing unit is operable to communicate instructions to any element of the communication device 2100 directly or by means of another element of the communication device 2100.

The disk 2106 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the apparatus, possibly removable and adapted to store one or more programs whose execution enables a method according to embodiments of the invention to be implemented.

The executable code may optionally be stored either in read only memory 2107, on the hard disk 2104 or on a removable digital medium such as for example a disk 2106 as described previously. According to an optional variant, the executable code of the programs can be received by means of the communication network 2103, via the communication interface 2102, in order to be stored in one of the storage means of the communication device 2100, such as the hard disk 2104, before being executed.

The central processing unit 2111 is preferably adapted to control and direct the execution of the instructions or portions of software code of the program or programs according to the invention, which instructions are stored in one of the aforementioned storage means. On powering up, the program or programs that are stored in a non-volatile memory, for example on the hard disk 2104 or in the read only memory 2107, are transferred into the random-access memory 2112, which then contains the executable code of the program or programs, as well as registers for storing the variables and parameters necessary for implementing the invention.

In an embodiment, the apparatus is a programmable apparatus which uses software to implement the invention. However, alternatively, the present invention may be implemented in hardware (for example, in the form of an Application Specific Integrated Circuit or ASIC). In such a case, logic units are configured to perform the steps of the method(s) in accordance with the present invention described above.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

FIG. 22a is a flowchart of an example method for managing, by a first base station, the retransmission to a second base station of missing data initially sent by a remote UE to a first base station through a relay UE according to one or more embodiments of the present invention.

For example, with reference to the wireless communication system shown in and described with respect to FIG. 1, the first base station performing the method 2200a of FIG. 22a may be the source base station 101, while the considered second base station may be the target base station 102 and the remote UE and relay UE may be respectively the remote UE 112 and the relay UE 110.

The method 2200a as shown in and described with respect to FIG. 22a, may be performed by software elements and/or hardware elements. The base station may be implemented in a communication device 2100 as shown in and described with reference to FIG. 21 with the method as shown in and described with respect to FIG. 22a being performed by one or more processing units, such as the central processing unit 2111.

In a step 2201a, one of the following triggering events is detected at the first base station:
the first base station receives a measurement report message from a remote UE connected to the first base station via a relay UE or from a relay UE. In one example the measurement report message is the MEASUREMENT REPORT 511a, as defined in FIG. 5;
the first base station initiates a connection adaptation process, from the first base station to the second base station, for a remote UE connected to the first base station via a relay UE served by the first base station. In one aspect of the invention, the initiation of the connection adaptation process consists in detecting by the first base station the need for performing connection adaptation for the remote UE. In another aspect of the invention, the initiation of the connection adaptation process consists in sending to the second base station a connection adaptation request message, such as CONNECTION ADAPTATION REQUEST message 521, as defined in FIG. 5;
the first base station receives a confirmation message from a second base station for a connection adaptation for a remote UE connected to the first base station via a relay UE served by the first base station. In one example, the confirmation message is the CONNECTION ADAPTATION ACK message 522, as defined in FIG. 5.

In one aspect of the invention, the connection adaptation may refer to a path switch.

In one aspect of the invention, the connection adaptation may refer to a handover.

In one example, upon detection of anyone of the aforementioned triggering events, the first base station may reconfigure a data expiration timer at the remote UE by sending a connection reconfiguration message to the remote UE, such as the CONNECTION RECONFIGURATION message 526a, 526b or 526c, as defined in FIG. 5.

In one example, the reconfiguration of the data expiration timer may consist in increasing the value of the data expiration timer.

In one another example, the reconfiguration of the data expiration timer may consist in setting the value of the data expiration timer to a value corresponding to the duration of the connection adaptation procedure.

In one example, the reconfiguration of the data expiration timer may consist in setting the value of the data expiration timer to an infinite value.

In one example, the reconfiguration of the data expiration timer may consist in disabling, or deactivating, or suspending the data expiration timer at the remote UE.

In one example, the data expiration timer is the PDCP layer discardTimer, as defined in 3GPP TS 38.323.

Upon reception of the any one of the CONNECTION RECONFIGURATION messages 526a, 526b or 526c or any message including the information for the reconfiguration of a data expiration timer, a remote UE may reconfigure its data expiration timer accordingly.

Reconfiguring the value of the data expiration timer may prevent the discarding by the Remote UE's PDCP layer of data packets, or PDCP Protocol Data Units (PDU), previously transmitted by the remote UE to the first base station. This allows for further retransmission, to the second base station, of the non-discarded data packets, or PDCP Protocol Data Units (PDU).

FIG. 22b is a flowchart of an example method for managing, by a remote UE, the retransmission to a second base station of missing data initially sent by a remote UE to a first base station through a relay UE according to one or more embodiments of the present invention.

For example, with reference to the wireless communication system shown in and described with respect to FIG. 1, the first base station performing the method 2200b of FIG. 22b may be the source base station 101, while the considered second base station may be the target base station 102 and the remote UE and relay UE may be respectively the remote UE 112 and the relay UE 110.

The method 2200b as shown in and described with respect to FIG. 22b, may be performed by software elements and/or hardware elements. The base station may be implemented in a communication device 2100 as shown in and described with reference to FIG. 21 with the method as shown in and described with respect to FIG. 22b being performed by one or more processing units, such as the central processing unit 2111.

In a step 2201b, one of the following triggering events is detected at the remote UE:
the remote UE sends a measurement report message to the first base station via a relay UE. In one example the measurement report message is the MEASUREMENT REPORT 511a, as defined in FIG. 5;
the remote UE receives a connection configuration message from the first base station. In one example the measurement report message is the CONNECTION CONFIGURATION 523b, as defined in FIG. 5;

In one aspect of the invention, the connection configuration message may refer to a path switch.

In one aspect of the invention, the connection configuration message may refer to a handover.

In one example, upon detection of anyone of the aforementioned triggering events, the remote UE may reconfigure a data expiration timer.

In one example, the reconfiguration of the data expiration timer may consist in increasing the value of the data expiration timer.

In one example, the reconfiguration of the data expiration timer may consist in setting the value of the data expiration timer to an infinite value.

In one example, the reconfiguration of the data expiration timer may consist in disabling or suspending the data expiration timer at the remote UE.

In one example, the data expiration timer is the PDCP layer discardTimer, as defined in 3GPP TS 38.323.

Reconfiguring the value of the data expiration timer may prevent the discarding by the Remote UE's PDCP layer of data packets, or PDCP Protocol Data Units (PDU), previously transmitted by the remote UE to the first base station. This allows for further retransmission, to the second base station, of the non-discarded data packets, or PDCP Protocol Data Units (PDU).

FIG. 22c is a flowchart of an example method for managing, by a remote UE, the retransmission to a second base station of missing data initially sent by a remote UE to a first base station through a relay UE according to one or more embodiments of the present invention.

For example, with reference to the wireless communication system shown in and described with respect to FIG. 1, the first base station performing the method 2200c of FIG. 22c may be the source base station 101, while the considered second base station may be the target base station 102 and the remote UE and relay UE may be respectively the remote UE 112 and the relay UE 110.

The method 2200c as shown in and described with respect to FIG. 22c, may be performed by software elements and/or hardware elements. The base station may be implemented in a communication device 2100 as shown in and described with reference to FIG. 21 with the method as shown in and described with respect to FIG. 22c being performed by one or more processing units, such as the central processing unit 2111.

In a step 2201c, one of the following triggering events is detected at the remote UE:
the remote UE completes a connection adaptation process from a first base station to a second base station. In one example, the completion of the connection adaptation process may consist in sending to the second base station a CONNECTION ADAPTATION COMPLETE message 525, as defined in FIG. 5;
the remote UE receives an uplink reception status report from the second base station. In one example the uplink reception status report is received through the UL RECEPTION STATUS REPORT 550b, as defined in FIG. 5;
the remote UE sends the missing data to the second base station. In one example, the missing data are sent through the UL User Data 512, as defined in FIG. 5;

In one aspect of the invention, the connection adaptation may refer to a path switch.

In one aspect of the invention, the connection adaptation may refer to a handover.

In one example, upon detection of anyone of the aforementioned triggering events, the remote UE may reconfigure a data expiration timer.

In one example, the reconfiguration of the data expiration timer may consist in resetting the data expiration timer or setting the value of the data expiration timer to an initial value.

In one example, the reconfiguration of the data expiration timer may consist in enabling or resuming the data expiration timer.

In one example, the data expiration timer is the PDCP layer discardTimer, as defined in 3GPP TS 38.323.

FIG. 22d is a flowchart of an example method for managing, by a remote UE, the retransmission to a second base station of missing data initially sent by a remote UE to a first base station through a relay UE according to one or more embodiments of the present invention.

For example, with reference to the wireless communication system shown in and described with respect to FIG. 1, the first base station performing the method 2200d of FIG. 22d may be the source base station 101, while the considered second base station may be the target base station 102 and the remote UE and relay UE may be respectively the remote UE 112 and the relay UE 110.

The method 2200d as shown in and described with respect to FIG. 22d, may be performed by software elements and/or hardware elements. The base station may be implemented in a communication device 2100 as shown in and described with reference to FIG. 21 with the method as shown in and described with respect to FIG. 22d being performed by one or more processing units, such as the central processing unit 2111.

In a step 2201d, upon completion of a connection adaptation process of a remote UE from a first base station to a second base station, the second base station may reconfigure the value of a data expiration timer at the remote UE.

In one aspect of the invention, the connection adaptation may refer to a path switch.

In one aspect of the invention, the connection adaptation may refer to a handover.

In one example, the completion of the connection adaptation process may consist in receiving by the second base station from the remote UE a CONNECTION ADAPTATION COMPLETE message 525, as defined in FIG. 5.

In one example, the second base station may check the status and/or the value of the data expiration timer at the remote UE prior to reconfigure the value of a data expiration timer at the remote UE upon connection adaptation process completion. In one example, the second base station may reconfigure the value of a data expiration timer at the remote UE only if it has been previously reconfigured by the first base station or by the remote UE itself.

In one aspect of the invention, the second base station may determine that the first base station has previously reconfigured the data expiration timer at the remote UE based on some information on the status and/or the value of the data expiration timer at the remote UE received from the first base station.

In one example, the information on the status and/or the value of the data expiration timer at the remote UE may be received from the remote UE through an RRCReconfiguration message, such as the CONNECTION ADAPTATION COMPLETE message 525, as defined in FIG. 5.

In one example, the information on the status and/or the value of the data expiration timer at the remote UE may be received from the first base station through an Xn message, such as the Xn RECEPTION STATUS INFORMATION message 540, as defined in FIG. 5.

In another example, the second base station may systematically reconfigure the value of a data expiration timer at the remote UE upon connection adaptation process completion.

In one example, the second base station may reconfigure the value of a data expiration timer at the remote UE by sending a CONNECTION RECONFIGURATION message 526d.

In one example, the reconfiguration of the data expiration timer may consist in resetting the data expiration timer or setting the value of the data expiration timer to an initial value.

In one example, the reconfiguration of the data expiration timer may consist in enabling or activating, or resuming the data expiration timer at the remote UE.

In one example, the data expiration timer is the PDCP layer discardTimer, as defined in 3GPP TS 38.323.

Upon reception of the CONNECTION RECONFIGURATION message 526d, a remote UE may reconfigure its data expiration timer accordingly.

FIG. 23 is a flowchart of an example method for managing, by a first base station, the retransmission of missing data initially sent by the first base station through a relay UE to a remote UE according to one or more embodiments of the present invention.

For example, with reference to the wireless communication system shown in and described with respect to FIG. 1, the first base station performing the method 2300 of FIG. 23 may be the source base station 101, while the considered remote UE and relay UE may be respectively the remote UE 112 and the relay UE 110.

The method 2300 as shown in and described with respect to FIG. 23, may be performed by software elements and/or hardware elements. The base station may be implemented in a communication device 2100 as shown in and described with reference to FIG. 21 with the method as shown in and described with respect to FIG. 23 being performed by one or more processing units, such as the central processing unit 2111.

According to one aspect of the invention, the first base station may record (in step 2301) some Sequence Number Information (SNI) related to the PDCP sequence number of the PDCP PDUs which have been received so far by a remote UE, upon detection of one of the following triggering events:
The reception from the remote UE of a measurement report, such as MEASUREMENT REPORT message 511b, as defined in FIG. 5;
The initiation of a connection adaptation process for the remote UE from the first base station to a second base station. In one aspect of the invention, the initiation of a connection adaptation process consists in sending, by the first base station to the second base station, a request for a connection adaptation for the remote UE, such as CONNECTION ADAPTATION REQUEST message 521, as defined in FIG. 5, to the second base station;
The reception, from the second base station, of a confirmation message for a connection adaptation for the remote UE, such as the CONNECTION ADAPTATION ACK message 522;

In one aspect of the invention, the Sequence Number Information (SNI) relates to the PDCP sequence number (SN) associated to the last PDCP PDU correctly received by the remote UE.

In one aspect of the invention, the Sequence Number Information (SNI) relates to a list of the PDCP sequence numbers (SN) associated to the PDCP PDU which have not been correctly received by the remote UE so far.

In one aspect of the invention, the Sequence Number Information (SNI) is determined based on the latest reception status provided by the RLC layer of the first base station and/or the latest Downlink Reception status report received from the remote UE.

At the previous RAN2 #121bis-e meeting, RAN2 discussed and listed some potential solutions for lossless data delivery for path switch through email discussion R2-2304305 [R2-2304305—Summary of [AT121bis-e][432] Candidate solutions for lossless delivery].
For uplink communication, 6 solutions have been proposed:
Solution-U1: Relay UE delays its RLC feedback to Remote UE
Solution-U2: Remote UE's PDCP retransmission based on remaining packets in the buffer.
Solution-U3: Remote UE's PDCP retransmission based on DL PDCP Status Report from target gNB.
Solution-U4: Enhancing RLC status report to Remote UE.
Solution-U5: Source Relay UE continues to transmit UL data to source gNB and gNB forwards to the target gNB.
Solution-U6: Source gNB sends a PDCP status report to the Remote UE before SN status transfer
   For downlink communication, 5 solutions have been proposed:
Solution-D1: Relay UE delays its RLC feedback to source gNB.
Solution-D2: Relay UE indicates the packet transmission status to source gNB.
Solution-D3: A PDCP status report sent from Remote UE to the source gNB.
Solution-D4: Enhanced Data forwarding from source gNB to target gNB per target gNB request (legacy PDCP status report based).
Solution-D5: Proactive Data forwarding from source gNB to target gNB
   Eventually, a down selection among the solutions has been done and the following agreements have been made [Chairman notes of RAN2 #121bis-e meeting]:

For uplink lossless data delivery for path switch, continue considering solutions U3 and U5 from R2-2304305. Other solutions are not pursued.

For downlink lossless data delivery for path switch, Solution-D4 is taken as the baseline solution and keep Solution-D3/D5 on the table for further decision at the next meeting.

In the following description, aspects related to the lossless delivery for sidelink relay inter-gNB path switching will be discussed.
RAN2 agreed at RAN2 #121 meeting that lossless data delivery in the inter-gNB i2x cases needs to be addressed, considering that a data loss may result from inter-gNB indirect to direct (i2d) or indirect to indirect (i2i) path switching if the source node (gNB for DL or Remote UE for UL) acknowledges the PDCP data PDU based on the RLC acknowledgements supplied by the relay UE.
Indeed, these acknowledgements indicate the transmission status at the first hop of the indirect path, without considering the transmission status over the second hop. Therefore, the PDCP entity of the source node is not aware of the actual reception status of the data at the destination node (Remote UE for DL or gNB for UL) that may not have been successfully delivered to the destination node.
As a result, when the discard timer expires, the source node may discard data acknowledged by the relay UE but not successfully received by the destination node, while such data should have been retransmitted to/from the target gNB after the completion of the inter-gNB path switch process.
For the uplink communication case, the solution U3 proposes that the remote UE PDCP retransmits data based on PDCP Status Report provided by the target gNB. As already stated in the TS38.300, the target gNB may send a report to the UE after a handover completion to minimize the unnecessary over-the-air retransmission, thus, a slight modification of the specification permits to support this solution. This solution allows the target gNB to request the remote UE to retransmit the exact PDCP SDU necessary to ensure a lossless path switch.
It may be proposed for RAN2 to consider the solution U3 as a potential solution for the lossless inter-gNB path switch.
However, the remote UE should still have the requested PDCP SDU in its PDCP buffer in order to be able to retransmit them. Thus, to ensure the lossless behaviour of the path switch procedure, the remote UE shall be prevented to discard data which have only been acknowledged by its lower layer upon expiry of its PDCP discard timer.
It can be observed that the efficiency of solution U3 may be impacted by some potential PDCP SDUs discarding at the remote UE due to potential discard timer expiry.
It may be proposed for UL transmission, during path switching, when considering solution U3, the discard timer of the remote UE should be (re)configured so as to prevent the discarding of PDCP SDU that need to be retransmitted. To do so, the two following options may be considered:
Option 1: the source gNB configures the remote UE PDCP discard timer to a value that would ensure a lossless data delivery for path switch e.g., an infinity value;
Option 2: the remote UE suspends its discard timer. The remote UE may suspend its discard timer upon reception of a path switch command from the source gNB or upon sending some measurement report to the source gNB.
   Upon completion of the path switch process and the retransmission of the PDCP SDUs (if any) to the target gNB, the discard timer should be resumed.
   It may be proposed for UL transmission, when considering solution U3, once the path switch has completed, the discard timer of the remote UE should be resumed to a normal usage. To do so, the two following options may be considered:
Option 1: the target gNB (re)configures the remote UE's PDCP discard timer once the retransmitted missing PDCP SDUs have been received from the remote UE;
Option 2: the remote UE resumes its PDCP discard timer after retransmission of the missing PDCP SDUs to the target gNB.
   While solution U3, enhanced with some appropriate discard timer management as discussed above, may ensure an inter-gNB path switch without data loss, this solution requires the remote UE to buffer unnecessary PDCP SDUs until the reception of the PDCP status report from the target gNB.
   In this respect, having the source gNB sending a PDCP status report to the remote UE before initiating the SN status transfer between the source and the target gNB, as proposed in solution U6, would allow to “clean up” the PDCP buffer from the useless data before the path switch of the remote UE.
   It may be proposed for RAN2 to consider the solution U6 as a potential solution for the lossless inter-gNB path switch.
   One main challenge for solution U6 is for the source gNB to send the PDCP status report to the remote UE at the appropriate timing, i.e., as close as possible to the effective path switch operated by the remote UE, so as to provide the remote UE with an accurate PDCP status reporting while ensuring that such PDCP status reporting would not be missed by the remote UE due to some link quality drop that could prevent the remote UE from actually receiving the PDCP status report.
   It can be observed that solution U6 may prevent unnecessary buffering at remote UE.
   It can be observed that, when applying solution U6, there is a risk of experiencing PDCP status report reception failure at the remote UE.
   Based on the above considerations, it appears that a good solution for lossless data delivery for path switch could be to mix the solution U6 (to minimize the required buffering at the remote UE) and the solution 3 (to ensure that the PDCP status report is actually received by the remote UE).
   It may be proposed for RAN2 to consider a complete solution based on both U6 and U3 so as to minimize buffering constraints while mitigating the risk of PDCP status report reception failure.
   Concerning solution U5, some companies have reported at the last meeting that this solution may have some limitations, for instance when considering a Uu link with poor quality. Some other companies also insisted on the complexity that would result from the need to keep Remote UE and Relay UE context even after the Remote UE's handover. Based on these considerations, it may be reasonable to withdraw solution U5.
   It may be proposed for RAN2 not to pursue the solution U5 for the lossless delivery issue.
   For the downlink communication case, the solution D4 proposes that the target gNB, after receiving the legacy PDCP status report from the remote UE upon PDCP re-establishment or PDCP recovery (following path switch completion), may request the source gNB to forward the missing DL PDCP SDUs. This is particularly true when the target gNB detects an inconsistency between the received PDCP status report and the DL SN status transfer previously received from the source gNB.
   It may be proposed that, based on D4 solution, the target gNB requests the source gNB to forward missing DL packets when detecting a SN mismatch between the PDCP status report received from the remote UE and the last SN status transfer received from the source gNB.
   This solution allows the target gNB to request the source gNB the exact PDCP SDUs required to ensure a lossless data delivery for path switch. However, in order to be able to retransmit the missing PDCP SDUs, the source gNB should still have them in its PDCP buffer. Thus, solution D4 should rely on extra buffering at the source gNB while preventing the source gNB to discard the PDCP SDUs for which the successful delivery of the corresponding PDCP Data SDU has not been confirmed by PDCP status report either in the source gNB before path switch or in the target gNB after path switch that may result from discard timer expiry.
   It can be observed that solution D4 efficiency may be impacted by some potential PDCP SDUs discarding at the source gNB due to potential discard timer expiry.
   Similar to the remote UE for UL, the source gNB have to manage its discard timer during the path switch procedure to avoid unexpected data discarding.
   It may be proposed for DL transmission, when considering solution D4, the discard timer of the source gNB should be disabled during path switching operation in order to prevent the discarding of PDCP SDUs that need to be retransmitted. To do so, the two following options may be considered:
Option 1: The source gNB configures its discard timer to a value that would ensure a lossless data delivery for path switch e.g., infinity value;
Option 2: The source gNB suspends its discard timer upon reception of a path switch acknowledgement from the target gNB or upon the sending of a path switch command to the remote UE.
   After the completion of the path switch and the retransmission of the PDCP SDUs to the target gNB (if any), the discard timer should be resumed.
   It may be proposed for DL transmission, after path switch, the discard timer of the source gNB should be resumed to a normal usage:
Option 1: source gNB configures its PDCP discard timer after the forwarding of the missing PDCP SDUs to the target gNB;
Option 2: source gNB resumes its discard timer after the forwarding of the missing PDCP SDUs to the target gNB.
   While solution D4, enhanced with some appropriate discard timer management as discussed above, may ensure a lossless inter-gNB path switch without data loss, this solution requires the source gNB to buffer unnecessary PDCP SDUs until the reception of the request from the target gNB.
   In this respect, having the source gNB receiving a PDCP status report from the remote UE before the SN status transfer between the source and the target gNB, as proposed in solution D3, would allow to “clean up” the PDCP buffer from the useless data. For instance, the remote UE could send its PDCP status report upon reception of the path switch command to provide an up-to-date status to the source gNB.
   Nevertheless, solution D3 may suffer from link quality issues that prevent the source gNB to receive the PDCP status report. Therefore, solution D3 should be considered in combination with solution D4 so as to handle the PDCP status report failure case. The failure could be detected by the target gNB as described above based on a detection of a mismatch between the SN reported by the remote UE and the SN status transfer from the source gNB.
   It may be proposed for RAN2 to consider a complete solution based on both D4 and D3 so as to minimize buffering constraints while minimizing the effects of PDCP status report reception failure at the source gNB.
   Concerning solution D5, many companies suggest that solution as a valid candidate and do not see the extra forwarding over Xn as a blocking issue. But in addition, to the waste of bandwidth over Xn, this extra forwarding may also lead to duplication over the air interface, as the target gNB has to prioritize all downlink data forwarded by the source gNB. Based on these considerations, it may be reasonable to withdraw solution D5.
   It can be proposed for RAN2 not to pursue the solution D5 for the lossless delivery issue.
   In summary, the following proposals and observations have been made:
   Proposal 1: RAN2 to consider the solution U3 as a potential solution for the lossless inter-gNB path switch.
   Observation 1: The efficiency of solution U3 may be impacted by some potential PDCP SDUs discarding at the remote UE due to potential discard timer expiry.
   Proposal 2a: For UL transmission, during path switching, when considering solution U3, the discard timer of the remote UE should be (re)configured so as to prevent the discarding of PDCP SDU that need to be retransmitted. To do so, the two following options may be considered:
Option 1: the source gNB configures the remote UE PDCP discard timer to a value that would ensure a lossless data delivery for path switch e.g., an infinity value;
Option 2: the remote UE suspends its discard timer. The remote UE may suspend its discard timer upon reception of a path switch command from the source gNB or upon sending some measurement report to the source gNB.
   Proposal 2b: For UL transmission, when considering solution U3, once the path switch has completed, the discard timer of the remote UE should be resumed to a normal usage. To do so, the two following options may be considered:
Option 1: the target gNB (re)configures the remote UE's PDCP discard timer once the retransmitted missing PDCP SDUs have been received from the remote UE;
Option 2: the remote UE resumes its PDCP discard timer after retransmission of the missing PDCP SDUs to the target gNB.
   Proposal 3: RAN2 to consider the solution U6 as a potential solution for the lossless inter-gNB path switch.
   Observation 2a: Solution U6 may prevent unnecessary buffering at remote UE.
   Observation 2b: When applying solution U6, there is a risk of experiencing PDCP status report reception failure at the remote UE.
   Proposal 4: RAN2 to consider a complete solution based on both U6 and U3 so as to minimize buffering constraints while mitigating the risk of PDCP status report reception failure.
   Proposal 5: RAN2 not to pursue the solution U5 for the lossless delivery issue.
   Proposal 6: Based on D4 solution, the target gNB requests the source gNB to forward missing DL packets when detecting a SN mismatch between the PDCP status report received from the remote UE and the last SN status transfer received from the source gNB.
   Observation 3: Solution D4 efficiency may be impacted by some potential PDCP SDUs discarding at the source gNB due to potential discard timer expiry.
   Proposal 7a: For DL transmission, when considering solution D4, the discard timer of the source gNB should be disabled during path switching operation in order to prevent the discarding of PDCP SDUs that need to be retransmitted. To do so, the two following options may be considered:
Option 1: The source gNB configures its discard timer to a value that would ensure a lossless data delivery for path switch e.g., infinity value;
Option 2: The source gNB suspends its discard timer upon reception of a path switch acknowledgement from the target gNB or upon the sending of a path switch command to the remote UE.
   Proposal 7b: For DL transmission, after path switch, the discard timer of the source gNB should be resumed to a normal usage:
Option 1: source gNB configures its PDCP discard timer after the forwarding of the missing PDCP SDUs to the target gNB;
Option 2: source gNB resumes its discard timer after the forwarding of the missing PDCP SDUs to the target gNB.
   Proposal 8: RAN2 to consider a complete solution based on both D4 and D3 so as to minimize buffering constraints while minimizing the effects of PDCP status report reception failure at the source gNB.
   Proposal 9: RAN2 not to pursue the solution D5 for the lossless delivery issue.

1. A method for use in managing data delivery in a wireless communication system comprising a plurality of User Equipment, UEs, for communicating data between a source base station and a remote User Equipment, UE, via at least one relay UE in a multi-hop communication path, the method performed by the remote UE comprising:
detecting a triggering event relating to a path switch, for the remote UE, to a new communication path; and
following detection of the triggering event, sending a status report to the source base station indicating data packets received by the remote UE;
wherein the triggering event comprises receiving, at the remote UE, a request for sending a Packet Data Convergence Protocol, PDCP, status report.

2. (canceled)

3. A method according to claim 1, wherein the request for sending a PDCP status report is received from the source base station.

4. A method according to claim 1, wherein the triggering event comprises receiving, at the remote UE, a path switch configuration for performing a path switch to the new communication path.

5. A method according to claim 4, wherein the path switch configuration is received from the source base station.

6. A method according to claim 4, wherein the path switch configuration is received from the relay.

7. A method according to claim 1, wherein the status report indicating data packets received by the remote UE is a Packet Data Convergence Protocol, PDCP, status report.

8-18. (canceled)

19. A method for use in managing data delivery in a wireless communication system comprising a plurality of User Equipment, UEs, for communicating data between a remote UE and a source base station via at least one relay in a multi-hop communication path, the method performed by the source base station comprising:
detecting a triggering event relating to a path switch, for the remote UE, to a new communication path; and
following detection of the triggering event, sending to the remote UE a status report indicating data packets received by the source base station;
wherein the triggering event comprises receiving, at the source base station, a request for sending a Packet Data Convergence Protocol, PDCP, status report.

20. (canceled)

21. A method according to claim 19, wherein the triggering event comprises sending, to the remote UE, a path switch configuration for performing a path switch to the new communication path.

22. A method according to claim 19, wherein the triggering event comprises sending, to the relay UE, a path switch configuration for performing a path switch to the new communication path.

23. A method according to claim 19, wherein the triggering event comprises receiving, at the source base station, a connection adaptation confirmation message from a target base station of the new communication path.

24. A method according to claim 23, wherein the connection adaptation confirmation message is a path switch acknowledgement message received from a target base station.

25. A method according to claim 19, wherein the status report indicating data packets received by the source base station is a Packet Data Convergence Protocol, PDCP, status report.

26-43. (canceled)

44. An apparatus for a sidelink relay communication system, the apparatus comprising:
one or more processing units configured to perform the method as recited in 1.

45. A non-transitory computer-readable medium comprising instructions which, when the program is executed by a computer, cause the computer to carry out the control method according to claim 1.

46. (canceled)
